(19) United States
(12) Patent Application Publication
(10) Pub. No.: US 2025/0106967 A1
(43) Pub. Date: Mar. 27, 2025

(54) DEVICE AND METHOD

(71) Applicant: BRYANT MEDICAL LTD, Lyne, Chertsey (GB)

(72) Inventors: Connor Bryant, Lyne (GB); Priyam Patel, Lyne (GB); Christopher Milborrow, Lyne (GB); George Forsythe, Lyne (GB); Marko Ver-Bancic, Lyne (GB)

(21) Appl. No.: 18/834,404

(22) PCT Filed: Jan. 31, 2023
(86) PCT No.: PCT/GB2023/050214

§ 371 Date: Jul. 30, 2024

(30) Foreign Application Priority Data
Jan. 31, 2022 (GB) 2201249.6
Nov. 10, 2022 (GB) 2216817.3

(51) Int. Cl. H05B 47/115

(52) U.S. Cl. CPC H05B 47/115

(57) ABSTRACT

There is described a device comprising a processor, wherein the processor is configured to be connected with an electrical component and a proximity sensor, and wherein the processor is configured to control a setting of the electrical component in dependence on a sensor output corresponding to an activation intensity within an activation intensity range.

### FIELD OF THE INVENTION

The invention relates to a device and method for controlling an electrical component, in particular in a hygienic environment, in particular in dependence on a sensor output. The invention also relates to an illumination device and method, in particular an illumination device which can be operated by actuation of a sensor. The invention further relates to a heating device and method, in particular a heating device which can be operated by actuation of a sensor.

### BACKGROUND OF THE INVENTION

Electrical devices are often required to be turned on and controlled in environments where it is beneficial to maintain clean and hygienic practices, for example in a dentist's surgery.

One such example is loupes. Loupes are small magnification devices used to see small details more closely. They are typically used in clinical settings by doctors and/or dentists but are also used more widely for example by jewellers and watchmakers. As wearers often use both hands in performing procedures, they will often choose to wear binocular loupes, which usually take the form of a pair of glasses with magnification lenses provided on the lenses. Loupes are worn, for example, by dentists not only for magnification but also to improve posture by avoiding slouching to view inside a mouth. In order to increase visibility, many users mount a headlight, with an associated battery pack, on the loupe arrangement. One aim of the present invention is to provide an improved headlight system for loupes.

Another example is heating devices. These may be used for preparing composite resin (for example, for use as dental cement). Such heating devices can preferably be heated to different temperatures for the preparation of different materials. A further aim of the present invention is to provide an improved heating device.

### SUMMARY OF THE INVENTION

Aspects and embodiments of the present invention are set out in the appended claims. These and other aspects and embodiments of the invention are also described herein.

According to an aspect of the invention, there is provided a device comprising a processor, wherein the processor is configured to be connected with an electrical component and a proximity sensor, and wherein the processor is configured to control a setting (or settings) of the electrical component in dependence on a sensor output corresponding to an activation intensity within an activation intensity range.

By actuating a change in settings in dependence on a specific activation intensity within an activation intensity range, the ergonomics of actuating settings of an electrical component can be improved. The activation intensity typically corresponds to an activation distance. Actuating a change in dependence on a specific activation intensity within an activation intensity range therefore can prevent actuation at too small a distance or too large a distance. By controlling settings in dependence on an activation intensity, accidental activation (for example, by a stray movement of a user, or due to their clothes or hair in a wearable device) can be prevented (without needing to reduce sensitivity). Furthermore, it can discourage and prevent a user from touching the appliance to control the settings. This can be advantageous in improving hygienic practices, as the device will need to be disinfected less frequently. It can also improve safety, in particular in the case of a heating device which gets hot, as the user should not need to touch the hot appliance to control a setting.

Preferably, the proximity sensor comprises an emitter configured to emit radiation and a detector configured to detect reflected radiation, and the activation intensity (and activation intensity range) refers to the intensity of the reflected radiation.

Preferably, said activation intensity range is a range either side of a particular activation intensity.

Preferably, the activation intensity (or activation intensity range) has both an upper and a lower limit. Preferably, the lower limit corresponds to an upper limit of distance or position within which activation occurs, and the upper limit corresponds to a lower limit of distance or position within which activation occurs. The distance or position may be relative to the device and/or the proximity sensor. This range can help to account for fluctuations in the position of a user's hand when intending to control the setting. The range may account for fluctuations in the ambient conditions, which can alter the detected intensity.

In preferable implementations, the said activation intensity range corresponds to an object being within a distance range of a particular activation position (or activation distance). This may preferably be within ±0.5 cm, or ±1 cm, or ±2 cm of said particular activation position; or within ±0.2 cm, or ±0.3 cm, or ±0.4 cm, or ±0.5 cm, or ±0.6 cm, or ±0.7 cm, or ±0.8 cm, or ±0.9 cm, or ±1 cm, or ±1.1, or ±1.2, or ±1.3 cm, or ±1.4 cm, or ±1.5 cm, or ±1.6 cm, or ±1.7 cm, or ±1.8 cm, or ±1.9 cm, or ±2 cm or ±2.1, or ±2.2, or ±2.3 cm, or ±2.4 cm, or ±2.5 cm, or ±3 cm of said particular activation position. This can further prevent accidental activation/actuation, which can therefore prevent causing changes to the settings accidentally. The activation position (or activation distance) is preferably relative to the proximity sensor and/or device, and is preferably located at a distance away from the sensor. The activation distance is preferably a distance between 0.5 cm and 10 cm from the sensor (and/or device), more preferably between 3 cm and 7 cm, and even more preferably between 5 cm and 6 cm. The activation distance may be 0.5 cm, or 1 cm, or 1.5 cm, or 2 cm, or 2.5 cm, or 3 cm, or 3.5 cm, or 4 cm, or 4.5 cm, or 5 cm, or 5.5 cm, or 6 cm, or 6.5 cm, or 7 cm, or 7.5 cm, or 8 cm, or 8.5 cm, or 9 cm, or 10 cm, or 10.5 cm, or 11 cm, or 11.5 cm, or 12 cm, or 12.5 cm, or 13 cm, or 13.5 cm, or 14 cm, or 14.5 cm, or 15 cm, or 15.5 cm, or 16 cm, or 16.5 cm, or 17 cm, or 17.5 cm, or 18 cm, or 18.5 cm, or 19 cm or 19.5 cm, or 20 cm.

The minimum distance or position (more proximate) of the range is preferably more than half the maximum distance or position (more distal/less proximate) from the sensor and/or device. The difference between the minimum distance or position (more proximate) and the maximum distance or position (more distal/less proximate) (i.e. the range) is preferably less than half the distance of the activation position from the sensor and/or device, preferably less than one third and more preferably less than one quarter. This can provide a comfortable activation distance while maintaining sensitivity of the detector. In some instances, the activation distance may be at least 1 cm, but may more preferably be between 1 cm and 4 cm, more preferably between 2 cm and 3 cm, and even more preferably approximately 2.5 cm. Preferably, the processor is configured not to effect an action (such as a control action or change) when the sensor output corresponds to an object within 1 cm of the sensor and/or device, more preferably within 0.5 cm. The processor may be configured not to effect an action (such as a control action or change) when the sensor output corresponds to an object within 0.1 cm, or 0.2 cm, or 0.3 cm, or 0.4 cm, or 0.5 cm, or 0.6 cm, or 0.7 cm, or 0.8 cm, or 0.9 cm, or 1 cm, or 1.5 cm.

Preferably the processor is configured to control the setting in dependence on a duration of the sensor output.

According to an aspect of the invention, there is provided a device comprising a processor, wherein the processor is configured to be connected with an electrical component and a sensor, and wherein the processor is configured to control a setting of the electrical component in dependence on a duration of a sensor output.

By activating control of a setting (or settings) in dependence on a duration of a sensor output, the system can help to prevent accidental actuation. It can also provide a more comfortable user experience, and/or provide the user with further control functions.

Preferably, the processor is configured to control the setting in dependence on a minimum time interval over which the sensor output is detected. This can prevent stray movements from causing changes to the settings. Preferably, the minimum duration is 0.5 s or 1 s or 1.5 s or 2 s or 3 s, or 3.5 s or 4 s, or 4.5 s, or 5 s, or 6 s, or 7 s, or 8 s, or 9 s, or 10 s. This can prevent accidental activation. This can also allow for the time during which an object (such as a user's hand) passes into the relevant position (such as the activation position), causing the sensor to read the activation intensity (even though the user may still consider themselves to be moving). This can create a more ‘natural’ feel to the user.

In some preferable implementations, the processor is configured to effect different actions in dependence on the duration over which the sensor output is detected. This can provide further control functionality. Preferably the processor is configured to effect a first action in dependence on a first duration (or time interval), and to effect a second action in dependence on a second duration (or time interval). The first duration (or time interval) may be longer or shorter than the second duration (or time interval). Preferably, the processor is configured to cycle between settings (for example brightness) in dependence on a first time interval and to switch between on and off settings in dependence on a second time interval. Preferably, the first time interval is at least 1 s, but may be 0.5 s, or 0.6 s, or 0.7 s, 0.8 s, or 0.9 s, or 1 s, or 1.5 s, or 2 s, or 2.5 s or 3 s. The second time interval may typically be at least 2 s, for example 2 s or 2.5 s, or may be at least 3 s, preferably 3 s or 3.5 s or 4 s or 4.5 s or 5 s. A further time interval may effect a third action. The further time interval may be 3 s or 4 s or 5 s or 6 s or 7 s or 8 s or 9 s or 10 s.

In some implementations, the processor may be configured to cycle (or move) a step through a cycle of settings in dependence on the sensor output.

According to a further aspect, preferably for versatility, there is provided a device comprising a processor, wherein the processor is configured to be connected with an electrical component and a sensor, and wherein the processor is configured to cycle (or move) a step through a cycle of settings in dependence on a sensor output.

Preferably the sensor output comprises the same activation (for example, activation position and/or intensity and/or duration). Typically, upon measurement of the activation intensity, the processor may be configured to cycle a step through a cycle of settings. This may correspond to an activation distance (or position). This can provide a user with improved control of the settings. The cycle of settings may comprise a plurality of settings. Preferably the cycle of settings comprises a series of corresponding settings, for example levels (such as brightness, temperature, volume etc.). Preferably the cycle of settings comprises at least three settings or at least four settings or at least five settings. As used herein, the term the cycle of settings' preferably connotes settings arranged in a particular order, wherein the order is arranged in a continuous and cyclical manner (i.e. the cycle starts at a first setting, then moves to the next setting, and so on; and once it reaches the last setting, then moves on to the first setting again).

The setting or settings may comprise on and off. The setting or settings may comprise brightness levels and/or colours of at least one light source. The at least one light sources may be a lighting component, such as a headlight, or an indicator light. The setting or settings may comprise temperature settings of a heating device. The temperature settings may be setpoint (target) temperatures of a heating device. The temperature settings may correspond or be linked to the light source, for example the colour of the light source. The on and off settings may form a different cycle of settings.

In some implementations, the processor may be configured to act in dependence on differing sensor conditions. This can allow recalibration due to changes, for example in the reflectance of the air, the temperature, the light conditions, a user setting a different activation position, and/or a user using different coloured gloves. Preferably, the processor is configured to adjust the sensor condition in dependence on detection of a baseline sensor condition. This may be in dependence on the ambient conditions, for example, in dependence on the ambient air conditions, and/or preferably wherein the ambient conditions comprise visible light levels and/or temperature. The ambient air conditions may comprise the intensity reflected from air. This can recalibrate (tweak or amend) the activation intensity which is relevant (i.e. corresponds to the activation distance). The processor may be configured to continuously recalibrate the activation intensity, for example corresponding to continuous monitoring of the reflectance of air.

The sensor may be a proximity sensor. In preferable implementations, the device further comprises the proximity sensor. Preferably, the proximity sensor comprises a window, and the window may be semi-transparent (or translucent). The proximity sensor may comprise a milky window. The proximity sensor may comprise a window comprising pigment, preferably white pigment, more preferably opaque white pigment. The translucence (or milkiness) of the window can enhance sensitivity of the sensor by increasing internal reflection. The window may be formed of glass or plastics material. This can ensure the window is durable. Preferably, the proximity sensor comprises a wipe-clean window. This can allow the window to be cleaned and/or disinfected, as can be very important for uses in a hygienic environment (such as a dentist's or doctor's practice, or operating theatre).

The proximity sensor may comprise an iris configured to attenuate radiation. This can be used to control the directionality of the sensor. If the sensor range is configured to a narrow cone, then the likelihood of accidental activation can be reduced.

The device may further comprise a light source (or illumination device), preferably associated with the electrical component, configured to convey information. As used herein, the term “associated with the electrical component” preferably connotes concerning information relating to a status of the component. This can be used to convey information relating to the settings without the need for a display screen. Display screens can degrade over time and can make the whole device/apparatus more difficult to clean. The light source (or illumination device) may comprise a plurality of light sources, wherein preferably the light sources are configured to be illuminated in different colours and/or at different intensities and/or at different times. Different colours and intensities can be used to indicate different information. For example, different colours may represent different setpoint temperatures. The light sources may preferably be configured to be illuminated in turn, thereby creating a pattern and/or an animated illumination. In some implementations, the electrical component may be a heating device and the light source may typically be configured to be illuminated in a portion indicating a relationship between current temperature and a target temperature of the heating device. For example, the portion of light sources illuminated may represent the current temperature of the heater on a scale from the starting temperature to the setpoint temperature, or from room temperature up to the setpoint temperature. This can further prevent necessity for a display screen. It can also indicate that a heater is becoming hot, which can act as a safety warning to a user.

According to a further aspect, there is provided a device for eyewear, comprising a headlight and a battery, wherein the battery is reversibly connectable via a magnetic connection. This arrangement can allow the battery to be removed and replaced or recharged easily. Preferably, the battery is configured to be positioned behind the head of a user and its weight is configured to counterbalance the eyewear. This can improve the comfort of a user.

Preferably the device comprises a connector, wherein the connector comprises pins and the battery comprises corresponding holes or vice versa. The arrangement of corresponding interconnecting formations can improve the security of the removable battery, so that it does not rotate relative to the eyewear and become detached. Preferably, the connector and the battery comprise corresponding magnets arranged symmetrically either side of the pins. This can further enhance the security of the connection. The battery and the eyewear may, in some implementations, further comprise magnets which are correspondingly protruding and recessed. Such an arrangement can provide a combination of magnetic connection and mechanical connection to improve the security of the connection. Preferably, the pins and holes are configured to form an electrical connection.

Preferably, the device is configured for clinical use and/or is formed of wipe-clean materials. This can improve the ease with which it can be cleaned. A casing or housing of the device may be made of metal, for example a medical grade metal, such as medical grade aluminium. The window may be formed of plastic or glass, and is preferably heat-resistant.

The device may further comprise the electrical component. The electrical component may be an electrical dental and/or medical component. The electrical component may be a lighting component (such as a headlight, a lamp, a torch etc.), a heating component (such as a heater), a dental tool component (such as a suction device, a drill, a scaler etc.), an audio component (such as a microphone or speaker), a camera component (which may be still or moving video), a display component (such as a monitor, projector or screen), a cooling component, a cleaning component and/or a curing tool component. The electrical component may be a culinary electrical component, as in such a use it can also be advantageous to avoid or at least minimise touching of the component.

According to a further aspect, there is provided a connector for rotatably connecting a headlight to eyewear, wherein the connector comprises a stop to limit rotation of the headlight towards a wearer. The connector may be a bracket. The connector may comprise a first portion and a second portion connected by a pivot, and preferably rotatably connected by the pivot. The stop may comprise a formation, preferably a protruding formation. The formation may be provided on the first portion or on the second portion.

According to a further aspect of the invention, there is provided a method of controlling a setting of an electrical component in dependence on a sensor output corresponding to an activation intensity within an activation intensity range.

According to a further aspect of the invention, there is provided a method of effecting an action in dependence on a duration of a sensor output. Effecting an action may preferably comprise controlling a setting.

According to a further aspect of the invention, there is provided a method of effecting an action in dependence upon detection of a sensor output by a sensor, wherein effecting an action comprises cycling a step through a cycle of settings. Effecting an action may preferably comprise controlling a setting.

According to a yet further aspect of the invention, there is provided a computer program product comprising computer implementable instructions for causing a programmable computer device to carry out the method.

According to a further aspect of the invention, there is provided a processor for controlling an electrical component, wherein the processor is configured to receive a sensor output from a sensor, and wherein the processor is configured to control settings of the electrical component in dependence on the sensor output indicating an object present within a distance range of the sensor, wherein the more proximate end of the range is a distance greater than zero.

According to a further aspect of the invention, there is provided a device comprising a processor and a proximity sensor, wherein the processor is configured to control settings in dependence on the proximity sensor determining an object at a distance greater than a first distance and lower than a second distance from the device, wherein the first distance is greater than zero (for example, greater than a zero distance from the device and/or sensor).

In some implementations, the apparatus may comprise a further sensor, preferably a temperature sensor and/or light sensor. These can be useful in calibration. Additionally, it can allow a device (in particular the sensor) to automatically turn on or off in certain conditions, for example when in the dark (which may indicate it is in the box, or that it is night time and that it is not currently required).

According to a further aspect of the invention, there is provided a method of controlling an electrical component, comprising: receiving proximity values; determining whether the proximity values are within a predefined range from a first value to a second value, wherein the more proximate value indicates a distance from the component greater than a zero distance; and actuating a change to settings of the electrical component in dependence on determining that the proximity values are within the range.

Preferably, the actuating a change in settings is further in dependence on a time interval over which the proximity value is determined.

In some implementations, the method further comprises: receiving values relating to a further sensor condition; and recalibrating the proximity values in dependence on the at least one further sensor condition.

According to an aspect of the invention, there is provided a device for use in a hygienic environment, comprising a sensor, a processor and an electrical component, wherein the processor is configured to control settings of the electrical component in dependence on an output of the sensor.

Such a device can be activated via the sensor, such that a user does not need to touch the device. This can offer hygienic advantages as it can reduce infection risk. It can also improve the longevity of devices as it reduces the need for constant cleaning (such as using disinfectants).

The electrical component may, for example, be a headlight or a heating element.

According to a further aspect of the invention, there is provided a controller for controlling an electrical component in a hygienic environment, comprising a processor, wherein the processor is configured to receive sensor reading, is configured to control settings of the electrical component in dependence on determining a first sensor condition, and is further configured to calibrate the first sensor condition in dependence on determining a second sensor condition.

The controller may be such that the first sensor condition and/or the second sensor condition comprises a time interval over which a sensor value is determined. In some implementations, the time interval of the second sensor condition is longer than the time interval of the first sensor condition. Preferably, the first sensor condition and/or the second sensor condition comprises a threshold sensor value.

In some implementations, the first sensor condition and/or the second sensor condition comprises a threshold sensor value range, preferably wherein a lower end of the threshold sensor value range is greater than zero.

Preferably, the sensor is a proximity sensor. More preferably, the controller is configured to not actuate the electrical component if the sensed proximity is below a threshold value, preferably wherein that threshold value is greater than a zero distance (for example a distance from the device and/or sensor). In preferable implementations, the first sensor condition and/or the second sensor condition comprises a threshold proximity range.

According to a further aspect of the invention, there is provided a device for eyewear, comprising a headlight, a sensor, and a processor.

The sensor can be used to control the headlight, and the processor may be configured to implement this.

According to a further aspect of the invention, there is provided a device for eyewear, the device comprising a headlight, and a battery and/or a sensor positioned atop the headlight.

As the battery and/or sensor is provided directly atop the headlight, external wiring can be eliminated. This can improve the longevity of the arrangement. Furthermore, it can improve the ease with which the system can be cleaned, enabling the arrangement to be cleaned thoroughly, which can improve hygiene and reduce infection control risks.

According to a further aspect of the invention, there is provided a device comprising a battery configured to be affixable to eyewear. Preferably, the battery is rechargeable. This means the battery can be recharged and then replaced.

The implementation of a battery directly on eyewear can eliminate the need for external wiring; it can also be used in balancing of weight distribution of the eyewear.

According to a yet further aspect of the invention, there is provided a sensor configured to be affixable to eyewear. The sensor can be used to detect relevant conditions and/or activation sensor conditions.

According to a further aspect of the invention, there is provided a device for a heater, configured to be connectable to a heating element, wherein the device comprises a sensor.

The sensor can be used to detect relevant conditions and/or activation sensor conditions in order to activate and/or control settings of the device and/or heater.

Preferably, the battery and/or sensor is reversibly connectable. This enables the component to be removed and replaced. The battery and/or sensor may be reversibly connectable via a magnetic connection. This can provide a strong but reversible connection. A magnetic connection also does not require small connecting parts, apertures, outlets, and/or crevices, which can be difficult to clean and disinfect.

Preferably, the headlight and/or battery and/or sensor is configured to be positioned on a nose bridge of (the) eyewear. Locating the headlight and/or battery and/or sensor on a nose bridge of the loupes can improve the comfort of a user, due to the distribution of the weight. Preferably the distribution of the weight is symmetrical relative to the nose bridge.

In preferable implementations, the device comprises a processor. This can be used to implement logic steps and controls. Preferably, the processor is configured to be connected with the electrical component and/or headlight and/or heating element and/or battery and/or sensor. This can allow the processor to implement commands to the components and/or in dependence on the components.

The processor may be configured to control settings of the electrical component and/or headlight and/or heating element in dependence on an output of the sensor. The user can activate changes to the settings by activating the sensor. In some implementations, the processor may be configured to control on and off settings. The processor may be configured to control brightness settings or temperature settings.

In preferable implementations, the sensor is configured to continue sensing in a default mode. As used herein, the term ‘default mode’ typically connotes the normal mode of operation, or the manner in which the device operates in the absence of any specific instructions. For example, the device will continue sensing unless the user implements specific instructions that it should stop sensing. In this case, sensing may be suspended over a defined period and then start again at the end of that period. This time period may be seconds (i.e. 30 seconds, to allow cleaning), minutes, or even hours (for example, overnight).

Preferably, the processor is configured to be adaptable to act in dependence on differing sensor conditions. The processor can be configured to act on a sensor condition which is defined in a calibration. The sensor condition can preferably be changed. This can enable the processor to be used such that different conditions can activate a command or commands.

Preferably, the processor is configured to perform calibration. This can define relevant sensor conditions for the particular operation. For example, different users may wish to use different sensor conditions to activate commands. The calibration may comprise recording a sensor condition. This sensor condition can be defined as a relevant sensor condition to activate commands. Calibration may be initiated upon detecting a sensor condition. For example, a sensor value may trigger initiation of calibration. This can allow the user to initiate calibration to define a relevant sensor condition.

In some implementations, the processor may be configured to adjust the sensor condition in dependence on detection of a baseline sensor condition. This may be a sensor condition dependent on the ambient conditions, for example the ambient air conditions. This may vary as a result of ambient fluctuations. By adjusting the sensor condition in dependence on this, improved stability and/or sensitivity can be maintained.

Preferably, the processor is configured to control settings in dependence on a value or values of the sensor output. The processor may be configured to control settings in dependence on a duration of the sensor output. This can help to prevent accidental activation.

The sensor may be a proximity sensor. This can allow a user to activate the sensor by bringing their hand near to it.

In preferable implementations, the proximity sensor comprises an emitter configured to emit radiation and a detector configured to detect reflected radiation, and the processor is configured to determine proximity of an object in dependence on the intensity of the detected reflected radiation. Preferably, the radiation is infrared radiation. Preferably the radiation has a wavelength in the range 780 to 1000 nm, preferably 800 to 950 nm, more preferably 880 to 920 nm, even more preferably in the range 890 to 910 nm, and most preferably approximately 900 nm. The ambient radiation at this wavelength range is typically low. The radiation may be emitted as a square wave, which can help in distinguishing reflected radiation from noise.

The proximity sensor may further comprise an aperture configured to attenuate the radiation, preferably attenuate a beam of the radiation, such that the aperture reduces the radius of the beam. The beam may preferably form a cone, which may define the activation and/or sensing area. This can allow the sensing area to be defined and/or altered. The aperture may preferably be an iris. The iris may be configurable such that the size of the aperture can be changed.

The processor may be configured to trigger a change in the settings upon detection of an activation intensity. The activation intensity may indicate an object is located at an activation distance from the sensor. The reflected intensity can also be dependent on further factors such as temperature or colour of the object; the use of an activation intensity can account for this. Preferably, the processor is configured to trigger a change in the settings of the headlight upon measurement of the activation intensity within a range either side of the activation intensity. This allows a margin of error. This may correlate to a position within ±1 cm of the activation distance, preferably within ±0.5 cm. It may correlate to an intensity within 10%, preferably within 5%, more preferably within 2%.

In preferable implementations, upon measurement of the activation intensity, the processor is configured to move a step through a cycle of settings. Each time the proximity sensor is activated, it may move a step through a predetermined cycle of settings. Preferably, the settings comprise at least on and off. More preferably, the settings further comprise brightness levels. In some implementations, the settings comprise temperature settings, for example setpoint temperature.

Preferably, the processor is configured to perform calibration to determine the activation intensity. The system can thus perform dynamic thresholding. The activation intensity can be adjusted for each user; for example, each user may naturally move their hand to a different position to activate the sensor. The system can also be recalibrated if a user changes the colour of their gloves.

The calibration may comprise recording an intensity measurement and setting the activation intensity as the recorded intensity. This can be performed as an initialization step, for example for a new user, or when a user changes gloves.

Preferably, the calibration is initiated upon detection of an intensity greater than a threshold value. The calibration step may be triggered by the sensor measuring an intensity greater than a threshold value over a time interval within a predefined range. For example, when a value greater than the threshold value is recorded for between 50 ms and 1 second, or preferably between 80 ms and 0.5 s.

The threshold value may be an intensity value greater than the intensity reflected from ambient conditions, preferably ambient conditions of air. This can cause the calibration to be triggered whenever an object is brought within proximity of the sensor.

The threshold value may be between 60% to 100% of the emitted intensity, preferably between 70% to 98%, more preferably between 80% and 95%, even more preferably between 85% and 95%, and most preferably between 90% and 92%. This can cause the calibration to be triggered when a user touches or almost touches the sensor, causing almost all of the emitted radiation to be reflected.

In preferable implementations, the processor is configured to adjust the activation intensity in dependence on an intensity indicative of ambient conditions. This may be in dependence on an intensity indicative of reflectance of ambient air. This may take place continuously, or at regular time intervals (for example intermittently). This can help to account for thermal fluctuations.

Preferably, the processor is configured to power off the electrical component and/or the sensor and/or the headlight and/or the heating element in dependence on detection of intensity above a threshold value over a particular interval. The interval is preferably at least 3 seconds, more preferably at least 5 seconds, and most preferably at least 6 seconds. This can initiate a ‘cleaning mode’, during which the device can be cleaned. The processor is configured to turn the electrical component and/or the sensor and/or headlight and/or the heating element back on again after a further time interval. The further interval may be a matter of seconds, minutes or hours. For example, the interval may be 30 s.

In some implementations the proximity sensor may comprise a window, wherein the window is semi-transparent. This can improve the sensitivity of the sensor due to internal reflections.

The sensor may, in some implementations, be arranged on a side of the device. Preferably the window is arranged facing away from a side of the device. This can allow a user to easily and comfortably lift their hand to activate the sensor.

The sensor may, in some implementations, be arranged on a top surface of the device. Preferably, the window is arranged facing upwards from the device. This can prevent stray movements (for example, from someone walking past) accidentally causing activation of the device.

In some implementations, the battery is within a housing having the approximate shape of a cube. This can provide enhanced balance of weight.

The battery is configured to be positioned behind a head of a user. This may be more comfortable for a user. The weight of the battery may be configured to counteract and/or counterbalance the eyewear and/or headlight.

The sensor may be configured to be affixable on an arm of (the) eyewear. This can provide a convenient position for the sensor, as it is easily accessible. It can also help to reduce the risk of accidental activation.

The sensor may be a visible light sensor. Preferably the device further comprises a further sensor, the further sensor preferably being an infrared sensor.

In preferable implementations, a power state of the device is dependent on an output of the visible light sensor. For example, the infrared sensor (and/or other components) may power off in the dark (i.e. below a threshold value of visible light).

The device may further comprise connector cables between the electrical component and/or the headlight and/or heating element and/or battery and/or sensor. Preferably the device also comprises a strap configured to secure the device over the head of a user, wherein the strap comprises the connecting cables. This can neatly and securely contain the cables.

Preferably, the device is reversibly attachable to (the) eyewear. As such, it may be removable, for example, for cleaning.

The device is preferably configured for clinical use. It may be configured for use with loupes, most preferably for use with dental loupes. It may be configured for use with dental heating equipment. It may be formed of wipe clean materials, such that the device can be disinfected.

The device may further comprise an illumination device, preferably wherein the illumination device is configured to convey information relating to a setting of the device and/or electrical component and/or headlight and/or heating element.

According to a further aspect, there is provided a device for a heater, comprising a heating element and an illumination device, wherein the illumination device is configured to convey information relating to the heating element, preferably settings and/or a status of the heating element.

This device can convey information to a user via the illumination device. This can eliminate the need for a display interface, which can be difficult to clean and/or likely to degrade with constant use and cleaning.

The device preferably further comprises a sensor. This can facilitate the user inputting commands and/or controlling the device without a display interface or (controller) buttons. Such buttons can be difficult to clean and/or are likely to degrade with constant use and cleaning.

In some implementations, the illumination device is configured to convey information in response to an output of the sensor.

The illumination device may be configured as ring-shaped.

Preferably, the illumination device comprises a plurality of light sources. These may be LEDs. Preferably, the light sources are configured to enable variation of light colour and/or intensity. The light sources may be RBG LEDs, comprising red, green and blue cathodes, so that a range of different colour effects can be created. Alternatively, LEDs of different colours may be provided, preferably wherein white LEDs are provided.

The illumination device may preferably be configured to be illuminated in a pattern. In preferable implementations, the pattern may be formed by altering an illumination colour and/or intensity. The pattern may be formed by illuminating different portions of the illumination device at different times and/or in different patterns and/or asynchronously. The pattern may comprise a segment of the illumination device being illuminated. The pattern may correspond to a setting and/or a status of the electrical component and/or heating element and/or headlight and/or sensor and/or battery.

According to a further aspect, there is provided an apparatus comprising the device as described, further comprising one or more of the following: a charger, one or more batteries, a strap, and eyewear. Preferably, the charger is configured to charge the one or more batteries; and preferably the eyewear comprises loupes.

According to a further aspect, there is provided a method of effecting an action in dependence upon detection of a sensor condition by a sensor.

The method may comprise effecting an action in dependence on a sensor condition value and/or in dependence on the time interval over which the sensor condition is detected.

The stipulation of a value and/or a time interval over which it is recorded can avoid accidental triggering of the action.

The method preferably comprises the steps of: performing a calibrating step in dependence upon detecting a sensor condition above a threshold value, wherein the calibrating step comprises recording a sensor condition and defining a sensor condition value as an activation value; and effecting an action in dependence on the sensor detecting the activation value. The calibration steps determine the activation value for the particular use setting, which can adapt the process for each setting.

The method may preferably further comprise effecting a different action in dependence on the time interval over which the activation value is measured. This can provide improved control over the actions. For example, measurement of the activation value over a first time interval may turn a device on and off, over a different time interval may change a setting of a device (for example brightness of a light), and over yet a different time interval may cause a device to power off for a period of time.

The calibrating step may be performed in dependence on detecting a sensor condition above a threshold value for a predetermined time interval. This can act as a trigger for the system to perform the calibrating step.

According to a further aspect, there is provided a computer program product comprising computer implementable instructions for causing a programmable computer device to carry out the method as described.

In general, the invention may comprise one or more of the following features in isolation or in any combination: a battery and/or sensor on top of a headlight; a battery and/or sensor and/or headlight configured to be affixable atop of eyewear; a sensor provided in a heating device; a sensor in communication with a heating element; a sensor configured to change settings; activation of a sensor being in dependence on a sensor condition value and/or the time over which it is detected; and defining a relevant sensor condition in an initialization (and/or calibration) step.

The term ‘sensor condition’ as used herein preferably connotes any condition which can be detected and/or measured by a sensor.

The invention extends to methods and/or apparatus substantially as herein described with reference to the accompanying drawings.

Any apparatus feature as described herein may also be provided as a method feature, and vice versa.

Any feature in one aspect of the invention may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

The term ‘comprising’ as used in this specification and claims preferably means ‘consisting at least in part of’. When interpreting statements in this specification and claims which include the term ‘comprising’, other features besides the features prefaced by this term in each statement can also be present. Related terms such as ‘comprise’ and ‘comprised’ are to be interpreted in a similar manner.

### BRIEF DESCRIPTION OF THE FIGURES

One or more aspects will now be described, by way of example only and with reference to the accompanying drawings having like-reference numerals, in which:

FIG. 1 shows a pair of loupes connected to a lighting apparatus according to a first embodiment of the invention;

FIGS. 2 shows an exploded view of the lighting apparatus of FIG. 1;

FIG. 3 shows an exploded view of the sensor apparatus of FIGS. 1 and 2;

FIG. 4a shows a first perspective exploded view of the battery and connector of the embodiment of FIGS. 1 to 3;

FIG. 4b shows a view of the connecting face of the battery of the embodiment of FIGS. 1 to 3;

FIG. 4c shows a second perspective exploded view of the battery and connector of the embodiment of FIGS. 1 to 3;

FIG. 4d shows a view of the connecting face of the connector of the embodiment of FIGS. 1 to 3;

FIG. 5a shows a perspective view of batteries and charger for the embodiment of FIGS. 1 to 4;

FIG. 5b shows a perspective view of batteries connected to the charger for the embodiment of FIGS. 1 to 4;

FIG. 5c shows a further perspective view of batteries and charger for the embodiment of FIGS. 1 to 4;

FIG. 6 shows a pair of loupes connected to a lighting apparatus according to a second embodiment of the invention;

FIG. 7 shows the sensor and headlight of the embodiment of FIG. 6;

FIG. 8a shows a first perspective exploded view of the sensor and headlight of the embodiment of FIGS. 6 and 7;

FIG. 8b shows a second perspective exploded view of the sensor and headlight of the embodiment of FIGS. 6 and 7;

FIG. 9a shows a perspective view of batteries and charger for the embodiment of FIGS. 6 to 8;

FIG. 9b shows a view of batteries connected to the charger for the embodiment of FIGS. 6 to 8, further connected to a plug;

FIG. 10a shows a cross-section view of a bracket of the headlight;

FIG. 10b shows a higher magnification of the bracket of the headlight;

FIG. 11 shows a perspective view of an exemplary heating device according to a further embodiment of the invention;

FIG. 12a shows a back view of the exemplary heating device of FIG. 11;

FIG. 12b shows a side view of the exemplary heating device of FIG. 11;

FIG. 12c shows a top view of the exemplary heating device of FIG. 11;

FIG. 13 shows a first exemplary logic flow of a processor;

FIG. 14 shows a second exemplary logic flow of a processor;

FIG. 15 shows a third exemplary logic flow of a processor;

FIG. 16 shows a fourth exemplary logic flow of a processor;

FIG. 17 shows a fifth exemplary logic flow of a processor; and

FIG. 18 shows a sixth exemplary logic flow of a processor.

### DETAILED DESCRIPTION

### Overview

The present invention relates to a sensor, such as a proximity sensor, implemented in order to provide hygienic control of devices, for example devices as may be used in a medical environment. These devices can be activated without requiring a user to touch them, which can improve infection control. It can also improve the longevity of such devices, due to reduced handling and a reduction in the frequency with which cleaning is required.

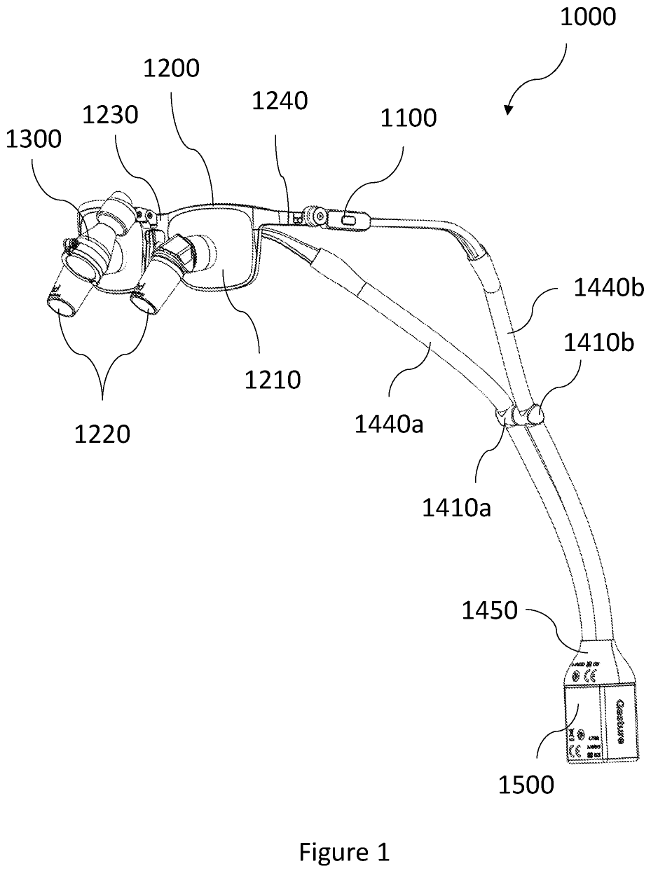

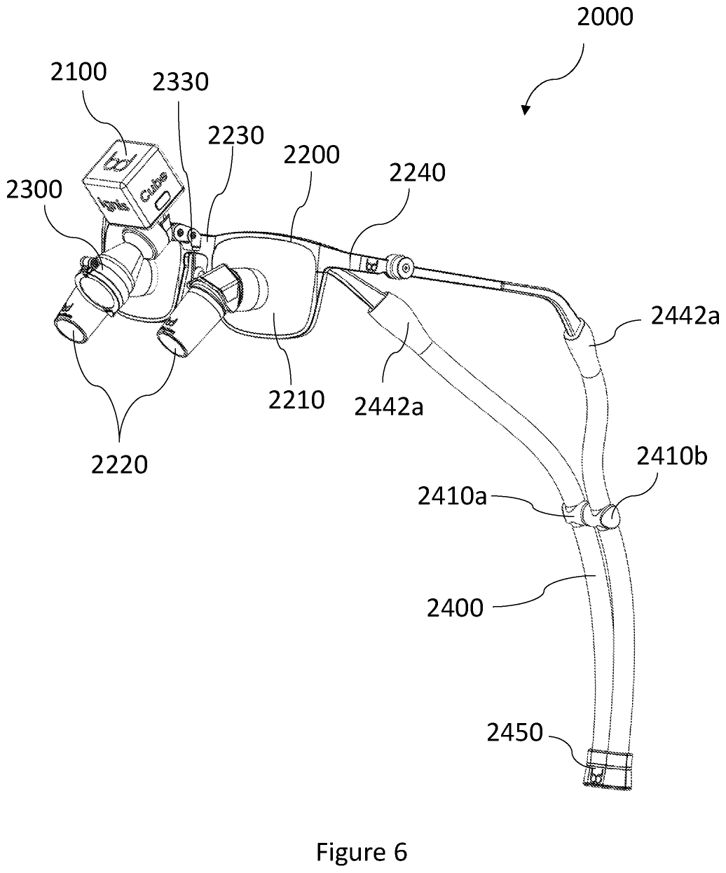

Firstly, the present invention provides a headlight for dental loupes which can be activated using a proximity sensor. A user can turn the headlight on and off and change functions of the headlight (such as brightness) by activating the proximity sensor. FIGS. 1 to 5 illustrate a first exemplary arrangement of the invention, and FIGS. 6 to 9 illustrate a second exemplary arrangement.

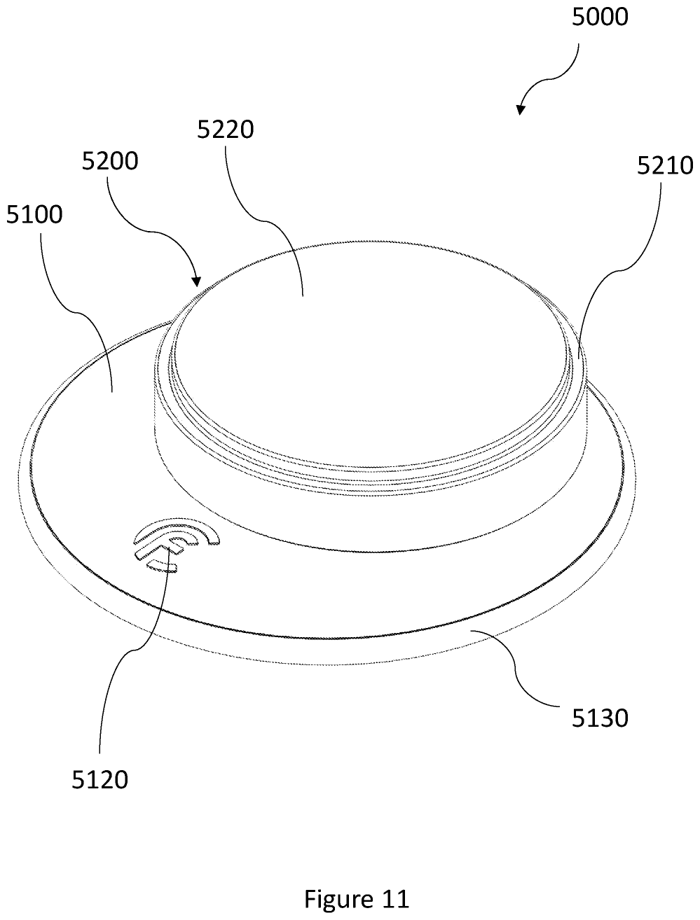

Secondly, the present invention provides a heating device (for example, for heating composite resin to be used as dental cement), which can be activated using a proximity sensor. A user can turn the device on and off and change the target temperature by activating the proximity sensor. FIG. 11 illustrates an exemplary embodiment of the heating device. In the case of a heating device, it is further advantageous that a user is not required to touch the device, which necessarily can become hot.

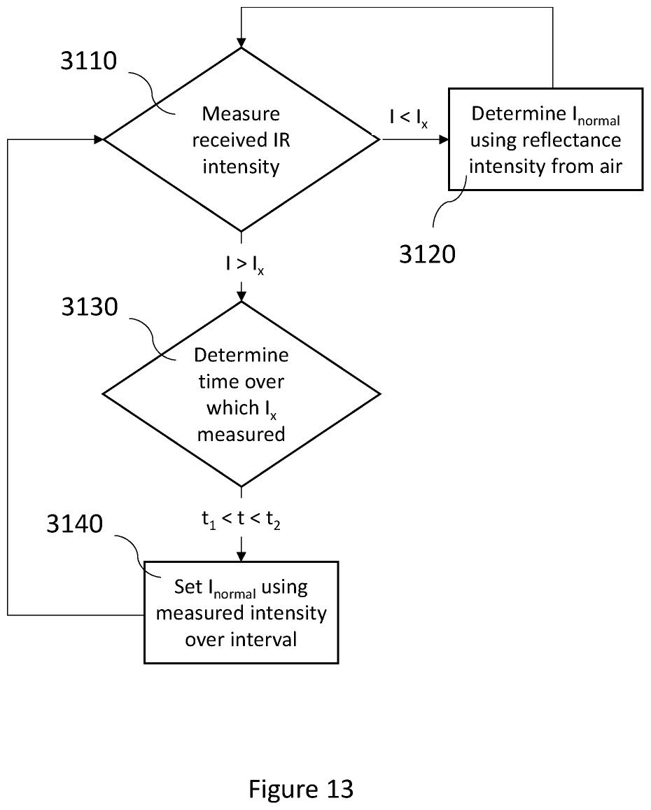

FIGS. 13 to 18 show exemplary logic flows of a processor as may be implemented in any of the embodiments.

### Arrangement of a First Exemplary Embodiment of the Headlight

FIGS. 1 to 5 illustrate aspects of a first exemplary embodiment of the invention. FIG. 1 shows an assembly 1000 comprising a pair of dental loupes 1200 onto which a lighting system activated via a proximity sensor is attached, according to the present invention. The loupes 1200 comprise lenses 1210, on which magnification lenses 1220 may be provided. When worn by a user, a bridge 1230 joining the lenses 1210 rests on the nose of a user, and two arms 1240 extend either side of a user's face and sit on their ears. A headlight 1300 can be connected to the bridge 1230, the headlight being configured such that it can illuminate a region corresponding to the focal area of the magnification lenses 1220.

A proximity sensor arrangement 1100 is located on one of the arms 1240 of the loupes 1200. This is used to control the headlight in a touchless manner; the methodology by which this is achieved will be described in detail later. The arms 1240 of the loupes 1200 can also be attached to a strap 1400, which comprises two straps 1440a, 1440b; one end of each of the straps 1440a, 1440b can be fitted over the ends of each of the arms 1240, and the other ends are joined together by a connector 1450. The connector 1450 can be attached to a battery unit 1500, which can be detached (for example, for charging) and reconnected. On each of the straps 1440a, 1440b there is provided a toggle 1410a, 1410b, which can be moved in either direction along the respective straps 1440a, 1440b. Each toggle 1410a, 1410b may comprise a magnet such that the toggles can be reversibly connected to one another via magnetic attraction. This can aid in securing the assembly at the back of a wearer's head. The straps 1440a, 1440 are preferably formed of a flexible wipe-clean material such as silicone, which can facilitate improved ease of cleaning of the strap 1400. (Features of a similar strap are described in further detail in the Applicant's earlier application GB2106256.7, which is herein incorporated by reference).

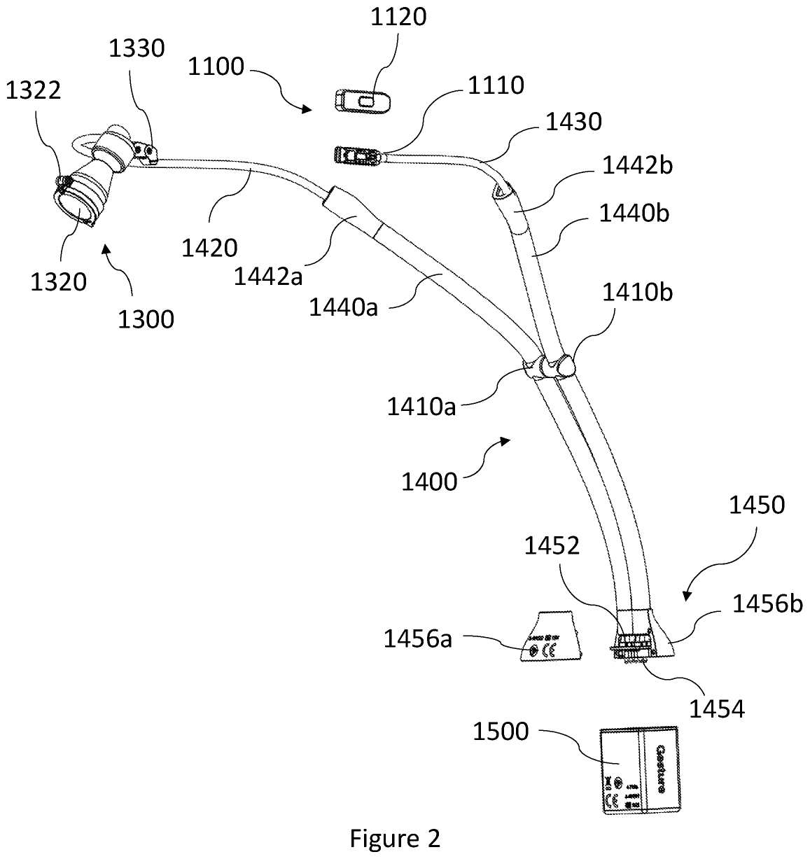

The assembly of the invention can be reversibly attached to loupe glasses of a generally compatible size. FIG. 2 shows an exploded view of the assembly without the loupes. The headlight 1300 comprises a housing enclosing a lighting apparatus, such as an LED (not shown). This typically emits white light but may emit other colours (such as a single colour or more than one colour light) if required. A lens may be provided to focus the light as it is emitted from an aperture on the active end of the headlight 1300. A filter 1320 may be provided over the lens, the filter being mounted in a ring-shaped holder. The filter 1320 can preferably be moved from a position over the lens (in which position it filters the light emitted) and a second position away from the lens (in which position, the filter is not in the path of the light emitted by the headlight). In order to achieve this, the connector 1322, which connects the filter to the headlight 1300, can be formed as a hinge such that the filter can be ‘flipped’ onto and away from the lens, or a pivot, such that the filter can be rotated onto and away from the lens. At the end of the headlight 1300 opposite the active end is a mount 1330, which is configured to be attachable to the bridge 1230 of a pair of loupes 1200. The mount 1330 may be formed of parts joined by rotatable joints; this can enable the position and angle of the headlight 1300 relative to the loupes 1200 to be adjusted.

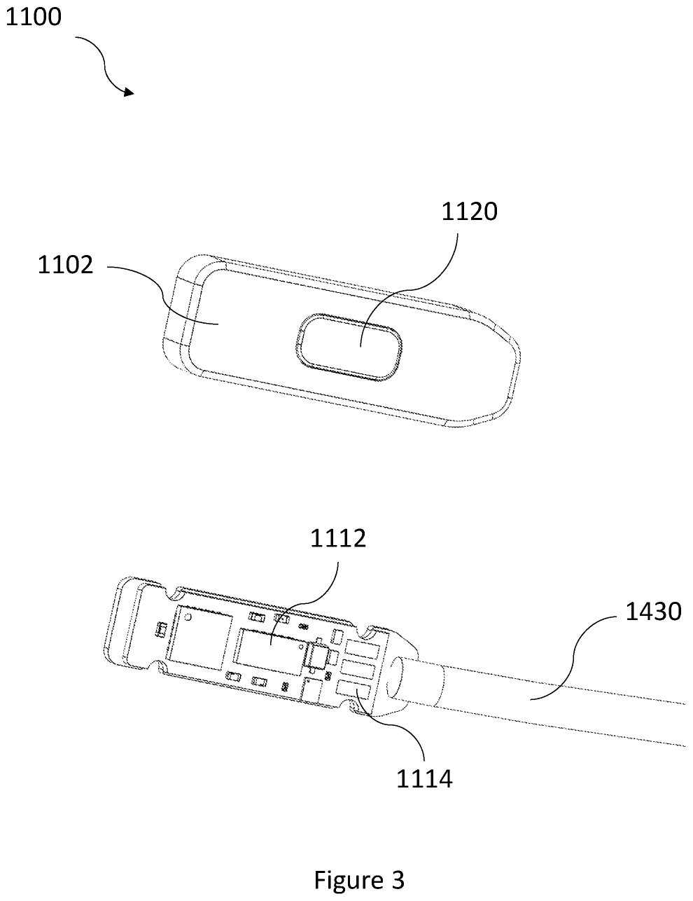

FIG. 2 shows the sensor assembly 1100 in an exploded, disassembled state. This is also shown in greater detail in FIG. 3. An outer casing 1102 is provided to enclose and protect the components, including the IR sensor 1112. The sensor 1112 comprises a transmitter, a receiver and associated processor (in the form of one or more printed circuit boards). Electrical connectors 1114 provide electrical connection with the wire 1430.

The outer casing comprises a window 1120, formed of a material which is transparent, or at least partially transparent to IR waves. The window 1120 may be formed of a glass or plastic material. The use of a semi-transparent glass or plastic, with a ‘milky’ appearance, can improve the sensitivity of the sensor by increasing internal reflection. The outer casing is preferably formed of a plastic material sealed such that the assembly can be cleaned without damage occurring to the components within.

Referring again to FIG. 2, the headlight 1300 is connected to an electrical source via a first, headlight wire 1420. The headlight wire 1420 is configured to run along one arm 1240 of a pair of loupes 1200, and down to the connector 1450, which connects to the battery 1500 (or other electrical energy source). The headlight wire 1420 is encased by a strap 1440a. The sensor 1100 is connected to an electrical source via a second, sensor wire 1430. This is configured to run along the other arm 1240 of the pair of loupes 1200, and down to the connector 1450. The sensor wire is encased by the other strap 1440b. Each of the straps 1440a, 1440b comprises a flexible end portion 1442a, 1442b, which is configured to be stretched over the end of one of the arms 1240 of a pair of loupes 1200. The end portions 1442a, 1442b are placed around the ends of the arms, and their resilience holds each strap 1440a, 1440b onto the loupes 1200. This connection can be easily and quickly reversed, and then reattached and so on.

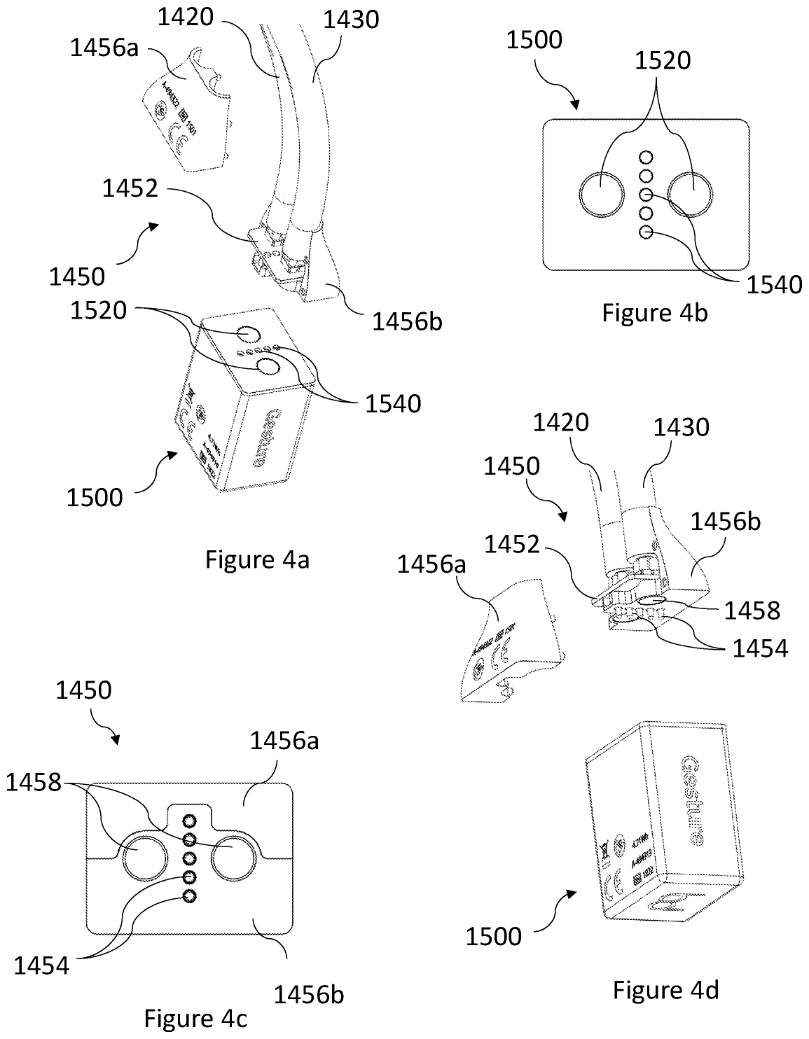

The other ends of each of the straps 1440a, 1440 (i.e., the end distal from the loupes 1200) are joined by the connector 1450, which connects to the battery 1500. This creates the electrical connection between the battery 1500 and the wires 1420, 1430. FIGS. 4a to 4d show different views of the connector 1450 and the battery 1500. In FIGS. 2 and 4a to 4d, the connector 1450 is shown in a disassembled state such that the connector circuit board 1452 can be seen. The outer casing of the connector 1450 is in two parts 1456a, 1456b, which are connected to enclose and protect the connector circuit board 1452. The two parts 1456a, 1456b of the casing may be connected in a reversible mechanical manner such as the engagement of pins within holes or similar, or via a more permanent engagement such as gluing or welding together.

The connector circuit board 1452 is electrically connected to the headlight wire 1420 and the sensor wire 1430. The connector circuit board 1452 further comprises pins 1454 which extend in a direction away from the wires 1420, 1430 (and so towards the battery 1500). The battery comprises a corresponding connection socket 1540, such that an electrical connection is made when the pins 1454 of the connector 1450 are placed within the holes of the socket 1540 of the battery 1500. This arrangement can help to prevent (or at least inhibit) the battery 1500 from rotating relative to the connector 1450, and thereby stabilizes the connection. (The same effect could be achieved using an arrangement of different geometry, for example the pins being provided on the battery and holes on the connector).

The connector 1450 further comprises one or more magnets 1458, which are configured to face corresponding one or more magnets 1520 on the face of the battery 1500. The magnetic connection between the two sets of magnets 1458, 1520 keeps the connector 1450 and the battery 1500 in engagement. This engagement can thus remain stable when the connector and battery hang at the back of a wearer's head during use. The battery may have a weight sufficient to counterbalance, or at least partially counterbalance the weight of the loupes 1200 and headlight 1300 to improve the comfort for the user. Accordingly, the magnetic connection needs to be sufficiently strong to retain the connection between the connector 1450 and the battery 1550 against gravity. The magnetic connection can further later be disassembled easily by hand, for example to replace the battery 1500 when it requires recharging. The number and arrangement of the magnets 1458 on the connector 1450 corresponds to the number and arrangement of the magnets 1540 on the adjacent face of the battery 1500. The magnets are preferably arranged symmetrically either side of the pins 1454, to ensure the pins 1454 remain firmly within the corresponding holes of the socket 1540 of the battery 1500, to ensure the electrical connection remains secure. In the preferable illustrated embodiment, each face comprises two magnets located either side of the row of pins 1454 (on the connector 1450) or corresponding holes of the socket 1540 (on the battery 1500). Alternative numbers of magnets may also be provided, although preferably they will be arranged symmetrically around the pins 1454 and corresponding holes 1540. As shown in FIGS. 4a to 4d, the magnets 1458 on the connector 1450 and the magnets 1540 on the adjacent face of the battery 1500 are correspondingly protruding and recessed. This can further improve the security of the connection, and further prevent relative rotation of the battery 1500 and the connector 1450.

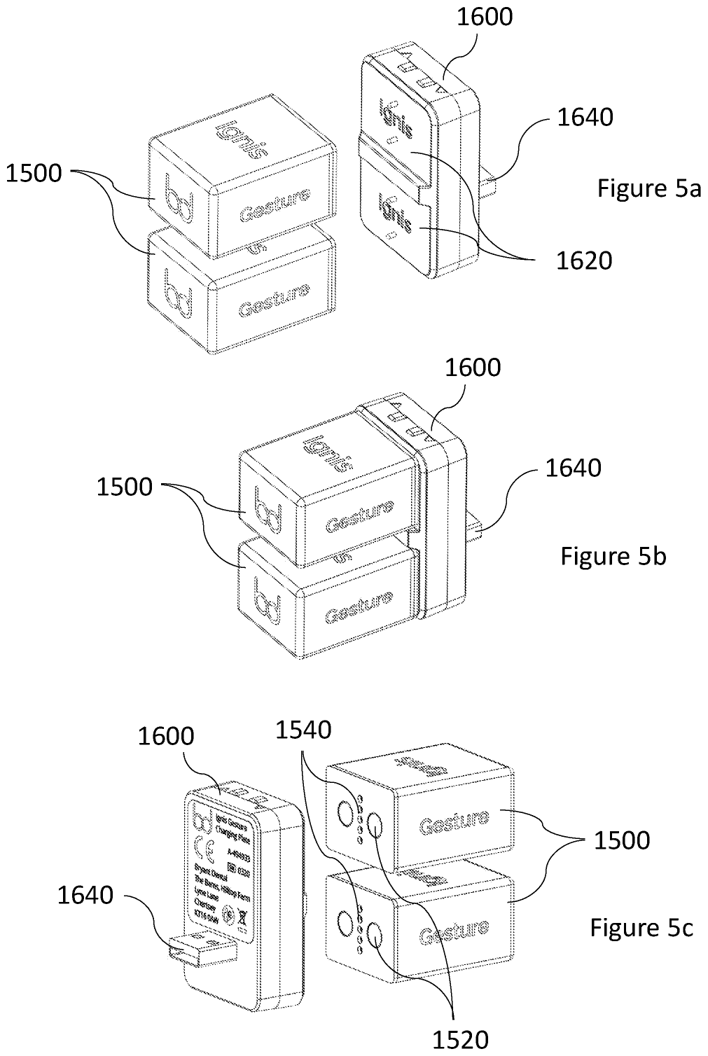

As previously mentioned, the battery 1500 can be reversibly detached from the connector 1450, and then reattached and so on. This allows the battery 1500 to be removed for recharging and replaced with a charged battery 1500. FIGS. 5a to 5c illustrate the charging arrangement. The battery 1500 can be connected to a charger 1600, which comprises docking ports 1620 and a USB connector 1640. The charger 1600 as illustrated comprises two docking ports 1620 so that two batteries 1500 can be charged simultaneously, and each docking port comprises two magnets corresponding to the two magnets 1520 on the face of the battery 1500. When a battery 1500 is placed on the docking port 1620, the interaction of the magnet aligns the battery 1500 into the correct position. The docking port 1620 may further comprise pins which correspond to the holes 1540 on the battery 1500.

### Arrangement of a Second Exemplary Embodiment of the Headlight

FIGS. 6 to 9 show a second exemplary arrangement of the present invention. FIG. 6 shows an assembly 2000 comprising a pair of dental loupes 2200 onto which a proximity sensor-activated lighting system according to the present invention is attached. The loupes 2200 are similar to those of the previous embodiment, comprising lenses 2210, on which magnification lenses 2220 may be provided, a bridge 2230 joining the lenses 2210 configured to rest on the nose of a user, and two arms 2240 extending either side of a user's face to rest on their ears. A headlight 2300 can be connected to the bridge 2230, the headlight being configured such that it can illuminate a region corresponding to the focal area of the magnification lenses 2220.

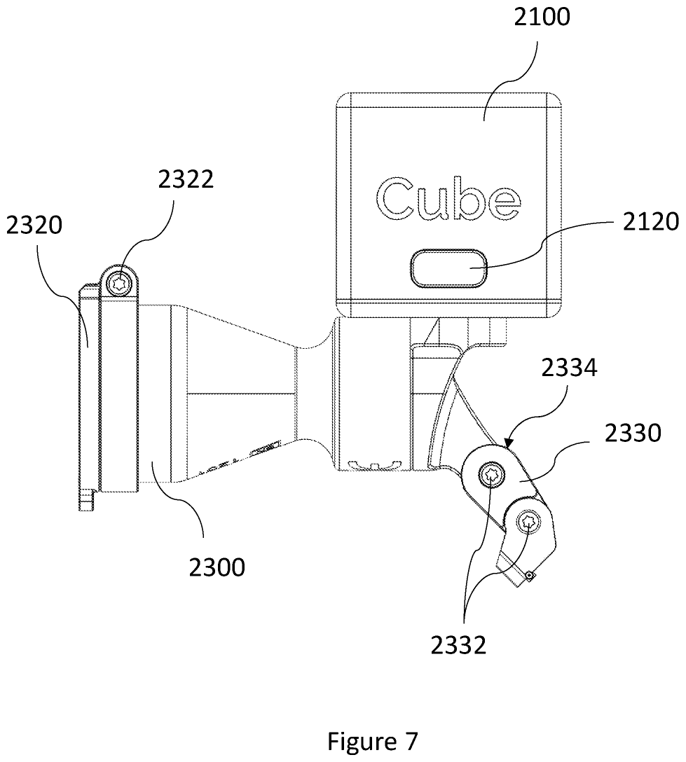

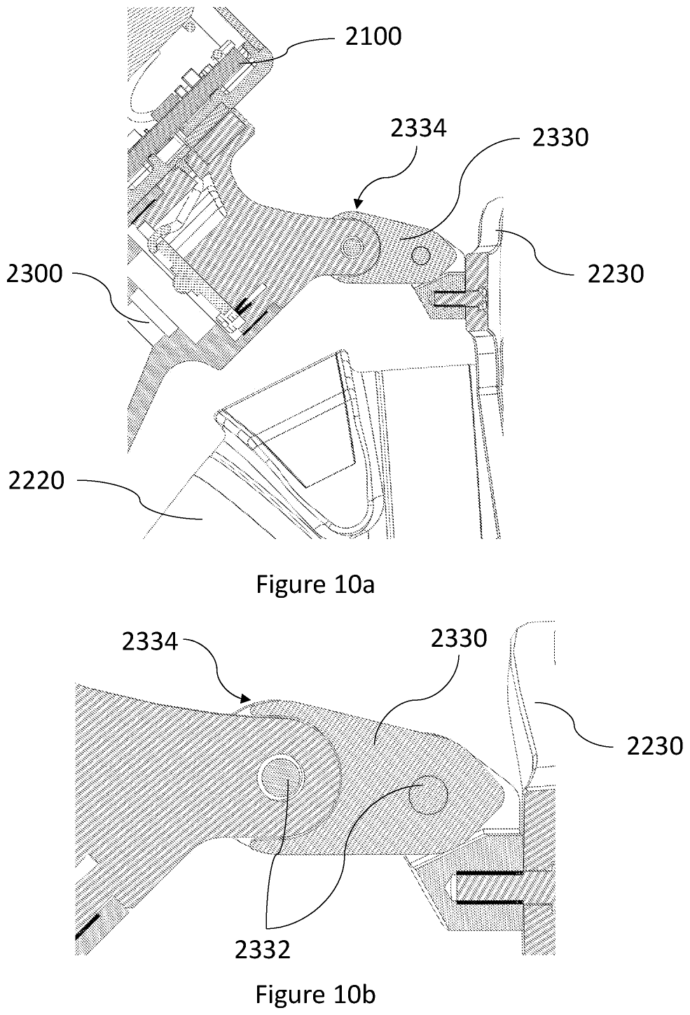

The assembly 2000 comprises a sensor component 2100, which sits on the top of the headlight 2300. The arrangement of the headlight 2300 and sensor component 2100 is shown in FIG. 7. The headlight 2300 has a similar arrangement as the headlight of the previous embodiment and may comprise a filter 2320 which can be moved over and away from the lens by means of a connector 2322 (which may be a pivot or a hinge). The headlight 2300 can be connected to the bridge 2230 of the loupes 2200 via a mount 2330. The mount 2330 may comprise sections which can be secured at different angles to one another via pivot screws 2332, so that the angle of the headlight 2300 can be altered. The mount 2330 may preferably comprise a stop 2334 to limit the possible rotation of the headlight 2300, as is described in more detail in relation to FIGS. 10a and 10b.

The sensor component 2100 sits directly atop the headlight 2300. The position of the sensor component 2100 is symmetrical relative to the bridge 2230 so that the weight is distributed approximately evenly on the wearer's nose. The sensor component 2100 comprises an IR proximity sensor, an associated processor and a battery encased within one housing. This eliminates the need for any external wires, which can aid the ease with which the device can be cleaned. The casing comprises a window 2120 adjacent to the IR sensor, which is formed of a material at least partially transparent to IR radiation, such that emitted and reflected IR can pass through it. This window is the same as that described in relation to the previous embodiment. In the illustrated embodiment, the sensor component 2100 is formed as a cube, but the skilled person would understand the invention could be implemented in a casing of a different shape.

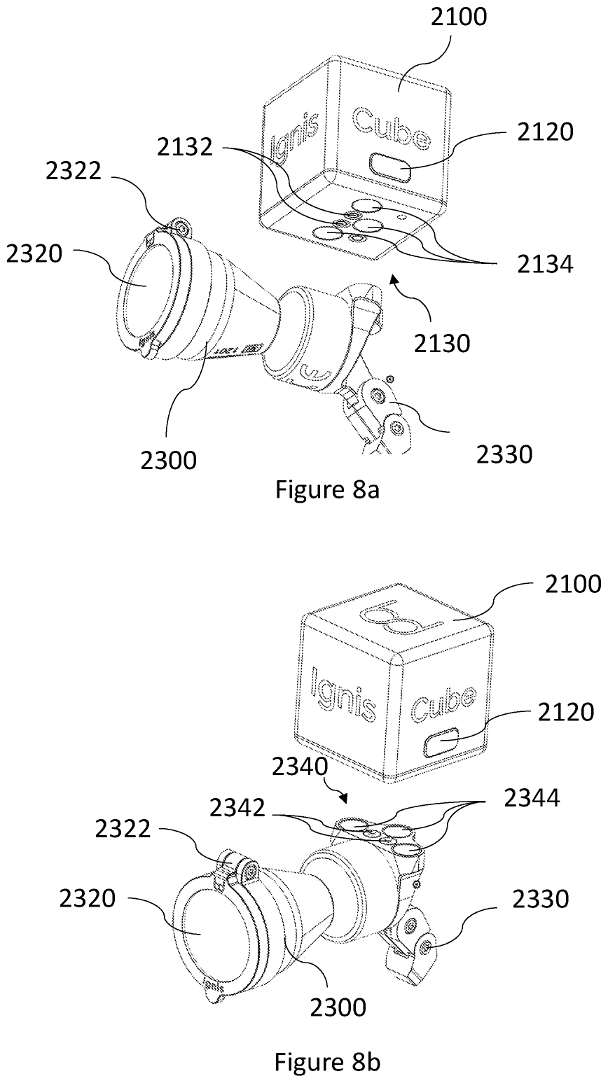

FIGS. 8a and 8b show the sensor component 2100 disconnected from the headlight 2300. The sensor component 2100 comprises a mounting face 2130 (as can be seen in FIG. 8a) which corresponds to a mounting pad 2340 on the top of the headlight 2300 (as can be seen in FIG. 8b). The mounting face 2130 comprises magnets 2134 which correspond to magnets 2344 on the mounting pad 2340. These interact to secure the sensor component 2100 to the headlight 2300. The magnets provide a secure but reversible connection, so that a user can disconnect the sensor component 2100 from the headlights, for example once the battery is run down and needs recharging. The mounting face 2130 further comprises electrical connectors 2132 which correspond to electrical connectors 2342 of the mounting pad 2340. This enables the sensor component 2100 to form an electrical connection with the headlight 2300. The battery within the sensor component 2100 can power the headlight 2300 and the processor can control its settings (such as on/off and brightness).

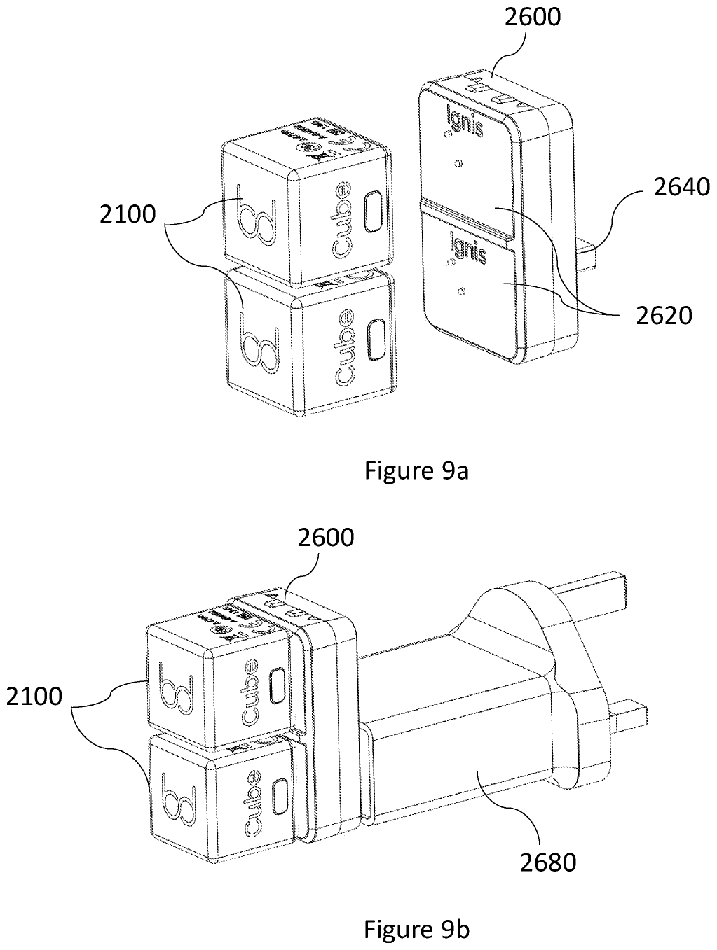

FIGS. 9a and 9b show a charger 2600 configured for charging the sensor component 2100 of the second embodiment of the device. The charger 2600 comprises a USB connector 2640 and docking ports 2620 configured to fit the sensor component 2100. As for the previous embodiment, the docking ports 2620 comprise magnets corresponding to the magnets 2134 on the mounting face 2130 of the sensor component 2100. The docking ports further comprise electrical connectors which correspond to electrical connectors 2132 on the mounting face 2130. In preferable implementations of the invention, the sensor component 2100 turns off (stops emitting IR radiation) when it determines that it is connected to the charger 2600. FIG. 9b shows an example of a plug 2680, to which the charger 2600 can be connected via the USB connector 2640.

Referring again to FIG. 6, the assembly loupes 2200 can be held in place on a user's head by means of a strap 2400 which passes behind the user's head, where it is joined by a connector. The user can secure the strap 2400 by means of magnetic toggles 2410a, 2410b. As the battery of this embodiment is located within the sensor component 2100, there is no requirement for wires to extend along the strap 2400. As such, a generic strap could be used with the present embodiment. However, in some implementations, it can be advantageous to tailor the weight of the connector block 2450 of the strap 2400 such that it has a weight that counterbalances the weight of the headlight 2300 and sensor component 2100. This can increase the comfort of the wearer. (An example of strap which can be used is described in the Applicant's earlier application GB2106256.7, which is herein incorporated by reference).

FIGS. 10a and 10b show a cross-section of the mount 2330 connecting the headlight 2300 to the bridge 2230 of the loupes 2200. The mount 2330 comprises a curved upper edge or ‘stop’ 2334 adjacent to the connection with the headlight 2300. This acts as a stop to limit the rotational movement achievable by the headlight 2300 relative to the mount 2330 (and therefore the loupes 2200) around the pivot point 2332 that connects them. The stop 2334 is configured to prevent the headlight 2300 being able to rotate to such an extent that it can make contact with a wearer's face (in particular, their forehead). This is implemented to prevent any burns or discomfort in the event that the headlight 2300 becomes hot during use. FIGS. 10a and 10b show a cross-section of the second embodiment of the headlight which clearly illustrates the stop 2334; however, this feature is also provided on the first embodiment. Any embodiment of the loupes with a headlight may optionally provide the stop 2334 (or not).

The components of both embodiments are typically formed of wipe-clean materials so that they can be easily cleaned and, if necessary, disinfected.

In some implementations of either embodiment, the system may further comprise an ambient light sensor. This can implement control logic to power off the device when it is in the dark (i.e. there is very little to no ambient visible light). This can conserve power when the device is not in use, for example overnight or when being transported in packaging.

### Exemplary Embodiment of the Heater Device

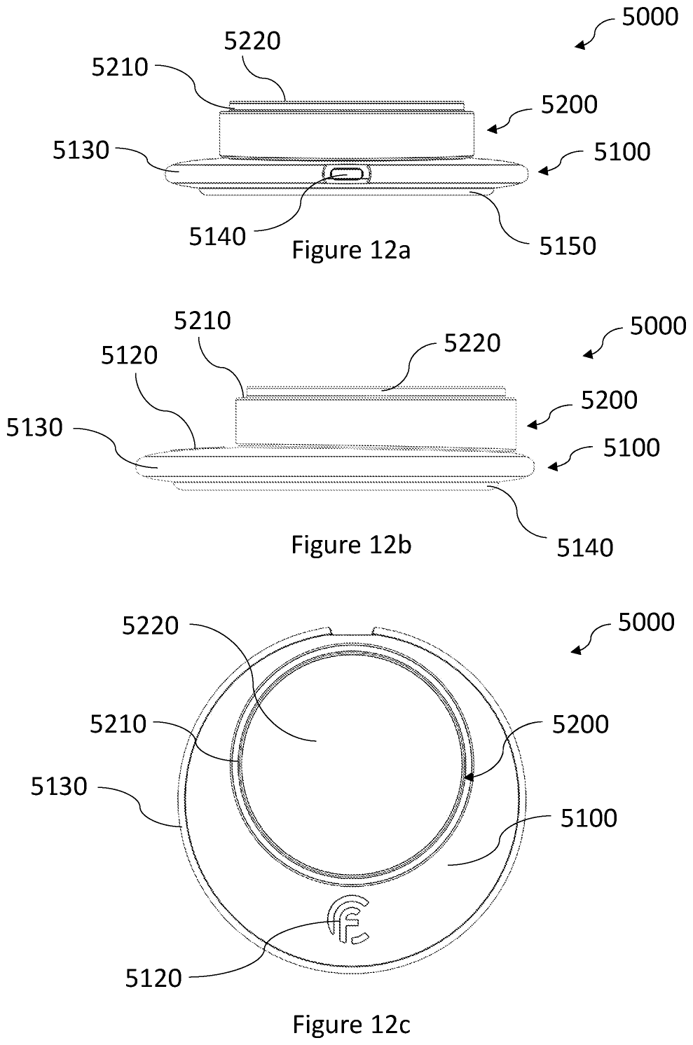

FIG. 11 shows a perspective view of an exemplary embodiment of a heater device 5000, according to the present invention. FIGS. 12a, 12b and 12c show a back view, side view and top view of the heater device 5000 respectively. The heater device 5000 comprises a base 5100, on which is provided a heater plate 5200. The base 5100 is configured as a generally flat disc, having a diameter typically between 8 cm and 15 cm, more preferably between 8 cm and 12 cm, and most preferably approximately 10 cm. The base typically has a depth of between 1 cm and 2 cm, preferably approximately 1.5 cm. The heater plate 5200 has a smaller diameter, typically between 6 cm and 8 cm, and preferably approximately 7 cm. Typically, the heater plate 5200 is not positioned centrally on the base 5100 but sits towards one edge of the base 5100. This arrangement means that there is provided a front portion of the base 5100 (i.e. the opposite edge to the one on which the heating plate 5200 is provided).

In this front portion there is provided a controller for turning the heater on and off and setting the target temperature of the heating plate 5200. A window 5120 is provided, which is typically formed from translucent (semi-transparent) or ‘milky’ glass or thermoresistant plastic. This may typically be formed of an injection-moulded transparent polycarbonate to which a white pigment has been added. Homogeneity of the white pigment is achieved via a mixing process during manufacture. The extent of the translucence or ‘milkiness’ can be controlled by varying the percentage of white pigment incorporated. An example of a material which can be used is LEXAN™ FR Resin 925AU. Behind the window 5120 is provided an IR sensor 1112, as provided for the illumination devices as previously described (and so the sensor arrangement broadly corresponds to that described for the embodiments of the illumination devices). The IR sensor 1112 will be described in detail in a later section. The milky window of the heater device 5000 is typically thicker and less transparent than the milky window of the illumination devices.

Around the perimeter of the base 5100 there is provided an illuminated ring 5130. The illuminated ring comprises a plurality of LED light sources provided beneath a cover. Preferably, the cover is formed of a translucent, milky glass or plastics material, in order to diffuse the light from the LEDs and so achieve a more uniform illumination effect. The LEDs are typically multicolour RBG LEDs, comprising red, green and blue cathodes, so that a range of different colour effects can be created. Alternatively, LEDs of different colours may be provided. Typically, the plurality of LEDs will further include white LEDs, to produce white light.

The heating plate 5200 sits approximately in the middle of the base 5100 and is typically formed as a short cylinder. Typically, the heating plate 5200 extends to a height at least 1 cm above the base 5100, and more preferably between 1 cm and 3 cm, even more preferably approximately 2 cm. The heating plate 5200 is typically configured to receive different attachments to allow for the heating of different materials. For example, different attachments may be configured to heat composite resins, sodium hypochlorite, and/or local anaesthetics. The heating plate 5200 is magnetic and configured to retain corresponding magnetic attachments. The attachments may be configured for the heating of different materials which may, for example, require different shaped vials. The heating plate 5200 comprises a groove 5210 around the perimeter of the upper surface, configured to engage with an outer rim of an attachment. This can aid in keeping the attachment in position. Additionally, the heating plate 5200 may comprise an anchoring point 5220, which comprises a magnet configured to engage with a corresponding magnet in the attachments, thereby anchoring the attachment into position.

The window 5120 is provided on the base 5100 such that it faces an upward direction in normal use. This can be advantageous in preventing accidental activation of the sensor, for example by a user passing by the device. Preferably the front portion of the base 5100, on which the window 5120 is provided, extends a distance from the heating plate 5200 such that a user does not need to place their hand too close to the heating plate to activate the sensor beneath the window 5120. This distance is typically at least 1 cm, but may more preferably be between 1 cm and 4 cm, more preferably between 2 cm and 3 cm, and even more preferably approximately 2.5 cm.

Heating devices which utilise buttons require the buttons to be made of a flexible plastic or rubber. Over time and with constant use and, for example, frequent exposure to disinfecting substances, such materials can degrade. Typically, both the base 5100 and heating plate 5200 of the present heating device are made of metal, for example a medical grade aluminium. The window 5120 and the cover of the illuminated ring 5130 are typically formed of glass or a plastic with good heat resistance. This can allow the device to be cleaned (for example disinfected) more easily, without degradation of the materials.

### Proximity Sensor

A corresponding proximity sensor 1112 is provided in all arrangements of the present invention. The sensor 1112 comprises an infrared (IR) emitter and a detector, the detector typically comprising a photodiode, in particular a photo-PIN-diode. The sensor assembly comprises a processor, which typically takes the form of one or more printed circuit boards (PCBs). For example, there may be provided a driver PCB and a sensor printed circuit board PCB, to which is connected an IR transmitter (emitter) and an IR receiver (detector).

The emitter emits infrared radiation, which is reflected off any nearby object, and the reflected IR radiation is detected by the detector. The intensity of the reflected radiation is a function of the proximity of the object, as the closer the object, the higher will be the intensity of the IR radiation which is reflected back to the detector. The proximity sensor 1112 can typically detect an object within 200 mm of the detector but has a greater sensitivity at a closer proximity, as the variation in the amount of light reflected is smaller at a further distance from the sensor. The reflected intensity of IR radiation is also dependent on temperature and the colour of the relevant object.

As has already been described, the window above the proximity sensor is translucent (semi-transparent) or ‘milky’. This is to increase the scattering of light through the window, as this can increase the sensitivity of the sensor. The translucence can be achieved by the addition of white pigment. Homogeneity of the white pigment is achieved via a mixing process during manufacture. The extent of the translucence or ‘milkiness’ can be controlled by varying the percentage of white pigment incorporated. An example of a material which can be used is LEXAN™ FR Resin 925AU.

The range of the emitter and, hence, detector is typically shaped as a cone (i.e. a detecting or sensing cone). As such, objects not directly aligned with the sensor 1112 can still be detected. The angle of this cone may be reduced by providing an aperture or iris in the light path of the IR emitter. This has the effect of limiting the angle at which an object may be detected, and thus determines the extent of the ‘directionality’ of the sensor 1112. Typically, no iris or an iris with a comparatively large radius defined is provided in a sensor used in an illumination device according to the present invention, and an iris of smaller radius is used in a sensor implemented in a heating device. This has the result that the heating device can only be activated by a user placing their hand within a small region directly above the window. This can prevent accidental activation, for example by a user walking past the heating device.

Infrared radiation of approximately 900 nm can be advantageously used, as the intensity of ambient radiation at this wavelength is typically low. The detector is chosen to have spectral sensitivity at a corresponding wavelength range. This can reduce the noise caused by ambient lighting. The emitter emits square-wave IR radiation, which can also be advantageous in isolating the noise in the detected reflection system, and thereby reducing the impact of noise caused by ambient light, for example, ambient flicker.

It can be important that the position of the sensor 1112 within the sensor assembly 1100 remains stable, so that there is consistency in the proximity detection. The assembly can be joined through a combination of soldering and UV glue. UV glue can be cured quickly and so allows more precise control over the relative position of components. It can also provide some flexibility, which can increase the longevity of the components which are likely to undergo thermal cycling. In some implementations of the invention, the sensor PCB is positioned at 90 degrees to the driver PCB and fits within a corresponding groove or cut-out portion in the driver circuit board.

### Sensing Methodology

When in use, the proximity sensor 1112 determines when an object is nearby, which can be used to control the functionality of the headlight or heater. For example, this can be used to turn a headlight on and off, and to change the brightness setting. Alternatively, this can be used to turn a heater on and off, and to choose a setpoint temperature. The system is configured to implement a control function of the headlight or the heater in dependence on the proximity sensor 1112 indicating that an object is within a distance range nearby. This allows the user to move their hand nearby the sensor to control the headlight or temperature settings, without needing to touch the equipment. This can provide a more hygienic control system, and, in the case of the heater, means that a user is not required to touch a device which can get hot, thereby improving safety.

However, without the inclusion of further logic steps, the system can be susceptible to unwanted activation of the controls caused by accidental movements or nearby objects. If the sensitivity of the detector is reduced to combat this, the system may then have difficulty in detecting deliberate control movements by the user.

The present invention implements two logic concepts in order to overcome this problem. Firstly, the system is configured to determine the time interval over which an object (such as a user's hand) is close to the proximity sensor. For example, the system will only implement a change if the object is detected nearby for a minimum time interval. Secondly, the system is configured to only implement control commands if the detector reading is within a certain range (corresponding to an object being within a certain distance range). This range has a lower (i.e. more proximate) distance limit which is greater than zero (i.e. the object must be at least a small distance away). This can discourage a user from touching the device, which is advantageous for the reasons discussed above. Additionally, in the case of a wearable device such as loupes, it prevents accidental activation by, for example, the wearer's hair or clothing.

The range within which the detector reading effects control commands to be implemented may be pre-set (or otherwise defined, for example by a processor) or may be defined by the system via thresholding. Thresholding comprises a calibration step of detecting nearby objects in order to determine a ‘normal’ value. This value is a function of the intensity of IR radiation reflected from the object, and so is chiefly dependent on the proximity of the object but can also be dependent on the colour of the object and the temperature (of both the air and of the object). This process can define an ‘activation position’ of the user's hand, whereby whenever a user raises and/or holds their hand to this position, the processor reads this as activation of the controls. The general range of the IR sensor is typically up to 20 cm, but as the sensitivity of the detector is lower at larger distances from the sensor (for example between 15 and 20 cm), the activation position is typically less than 15 cm.

The activation position is preferably between 0.5 and 10 cm, and more preferably between 3 and 7 cm. The activation position defined by the system may have both an upper and a lower limit, distinguishing it from a proximity sensor configured to determine an object within a certain distance. For example, the system may only effect a control command to be implemented if the user's hand is determined at an activation distance of between 5 and 6 cm away from the sensor. This could also be referred to as an activation distance of 5.5 cm and a symmetrical range of ±0.5 cm. The activation distance could be any distance within the range of 0.5 cm to 20 cm, preferably within 0.5 cm to 10 cm, more preferably within 3 cm to 7 cm (such as 3 cm, 4 cm, 5 cm or 6 cm). It may be predefined or set via ‘dynamic thresholding’. The upper and lower limits may be defined symmetrically about the activation distance, such as ±0.5 cm, ±1 cm, ±1.5 cm or ±2 cm, or asymmetrically. Different upper and lower activation distance limits and ranges may be desirable for the implementation of the sensor in the illumination device and the heating device. This is due to the different geometries of the arrangements. Additionally, it can be advantageous to implement a different activation distance for the heater device, which is further away, so that a user does not need to move their hand as close to the heating plate. Normal distances may be pre-set into the devices or defined remotely, but they preferably may also be configured to enable a user to define new working distances in accordance with the user's working pattern, referred to as ‘dynamic thresholding’.

The system uses dynamic thresholding to determine the relevant range of the detector reading for the activation position of each user. The user can hold their hand adjacent to the sensor to calibrate the system. For example, if the user holds their hand to the system for a predetermined time interval, the system is configured to recalibrate the relevant range of the detector reading. Each different user may naturally hold their hand to a slightly different position, and so recalibration can be performed each time a different person uses the system. As the reading also depends on the colour of the object, it can also be advantageous to recalibrate the system if the user changes their clinical gloves to ones of a different colour, for example from pink gloves to black gloves.

When there is no object in the proximity of the sensor 1112, some IR radiation will still be reflected from the air. The system performs continuous thresholding by performing reflectance measurements on the air. This can be used to track the ‘background’ reflectance reading, which can change as, for example, the temperature of the air varies. (The temperature may fluctuate due to external factors and due to heat generated by the system itself). The system can use this air reflectance value to continuously recalibrate the recorded relevant range of the detector reading. FIG. 13 illustrates a simple logic flow of an example initialization process of the thresholding as implemented by the processor. At step 3110, the detector measures the reflected IR intensity. If the intensity is below a threshold value, Iₓ, then the system simply detects the intensity of the IR radiation reflected from the air, and determines the normal intensity, I^{normal}, from these readings as the intensity of reflectance from the air (step 3120). However, if the system detects an intensity greater than the defined threshold value, Iₓ, the system moves to step 3130, in which it is determined the timescale over which the Iₓ is measured. If the time interval, t, is determined to be with in a first range (t₁ to t₂), then the system enters a calibration mode. At step 3140, the value of the reflected intensity over a set timescale is used to determine the ‘normal’ intensity value i.e. the intensity value which is determined to be indicative of the user's hand being present, which will correspond to the activation intensity. Thereafter, when the user lifts their hand to this position (the activation position), the controls of the headlight will be activated. The system includes an error in this intensity value such that the intensity value only needs to be within a range of the defined normal value, Iₙₒᵣₘₐₗ. This can account for fluctuations in the intensity, for example due to temperature fluctuations or the uneven surface of the user's hand, and small variations in the exact position of a user's hand. This range may equate, for example, to within approximately ±0.5 cm, within ±1 cm or ±2 cm. The ‘normal’ intensity value can be redefined if the process is reactivated again upon detection of an intensity above the threshold value Iₓ. In preferred embodiments, the devices further comprise sensors which measure background conditions (for example light and/or temperature). The associated readings can inform a feedback loop whereby the parameters of the thresholding functions are adjusted accordingly, in order to maintain a steady activation distance (and associated margin of error). In the particular case of the heating device, the heat emitted from the device's chassis can influence the readings from the sensor. Based on the current temperature of the heating element of the device, a software control feedback loop constantly tweaks the parameters of the thresholding functions to maintain a steady threshold distance for activation (activation position), resulting in a seamless use of the device.

By way of example, this system calibration is triggered when a user touches their hand to, or very near to, the window 1120 of the sensor assembly 1100. This causes a peak in the measured value of the reflected IR intensity as almost all of the radiation from the emitter is reflected back to the detector. In some cases, the threshold value, Iₓ, is defined between 80% to 95% of the emitted intensity, preferably 85% to 95%, more preferably 90% to 92%, and even more preferably approximately 91%. The timescale over which this must be detected for the system to move to initialization (step 3140) may for example be between 80 milliseconds and 0.5 seconds (in which case t₁ is 80 ms and t₂ is 0.5 s). The timescale may be between 50 ms and 2 seconds, preferably between 50 ms and 1 second, and most preferably between 80 ms and 0.5 s. An example value for the interval over which the intensity is measured, in order to define a normal value, is 3 seconds. The interval may be between 1 and 6seconds, preferably between 2 and 4 seconds, and most preferably approximately 3 seconds.

The measured background reflectance reading will, to some extent, be a function of the window over the sensor. For example, if the window is thicker or ‘milkier’ (i.e. less transparent), light will be scattered to a greater extent. This can lead to more noise being detected by the sensor, and hence a higher background reflectance reading. Threshold values are defined to be sufficiently distinct from the background reflectance values that activation only occurs when a user deliberately positions their hand in the activation position. As such, different threshold values may be defined for different arrangements of the sensor, such as different windows. It can be advantageous to increase the scattering of light through the window, as this can increase the sensitivity of the sensor. For example, this can improve the sensitivity of a detector at a larger distance. This can be advantageous when implemented in the heating device, as it can allow a user to activate the device from a greater distance, meaning a user does not need to move their hand in close proximity with the heating plate. Accordingly, different threshold values will typically be defined for the different implementations.

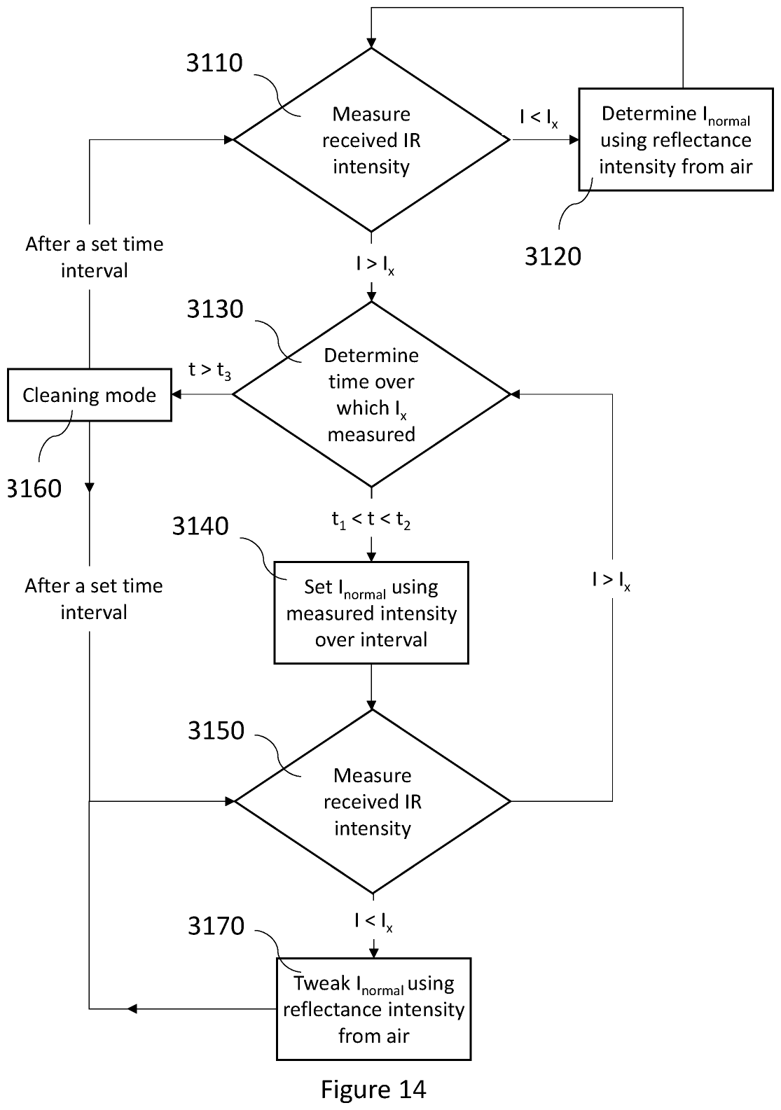

FIG. 14 illustrates a similar embodiment of the initialization thresholding of the invention as shown in FIG. 13, with the additional inclusion of optional further steps. Once the normal intensity value, Iₙₒᵣₘₐₗ, has been set at step 3140, the system continues to measure the received IR intensity (step 3150) so that it can track the reflectance intensity of air (which may vary due to temperature fluctuations), and continuously tweaks the defined value of Iₙₒᵣₘₐₗ accordingly (step 3170). Additionally, further logic steps may be implemented by which the system can be made to enter a ‘cleaning mode’, 3160, in which the sensor turns off for an interval of time. This can allow the machinery to be cleaned. The cleaning mode can be triggered by the measurement of an intensity value greater than a threshold value over a period longer than a defined time period, t₃. After an interval of time (this may, for example, be between 15 s to 90 s, preferably between 15 s and 60 s, and most preferably approximately 30 seconds), the sensor turns back on again. It may return to the initial settings, or it may return to the settings of the previous session. As an example, the cleaning mode can be initiated by touching the sensor for at least 6 seconds, in which case t₃ would be 6 seconds. It can improve functionality if the value of t₃ is longer than t₂, and is preferably significantly longer, so that there is a clear definition between the modes. The length of t₃ may be between 3 and 10 seconds, preferably between 5 s and 8 s, and most preferably 6 s to 7 s.

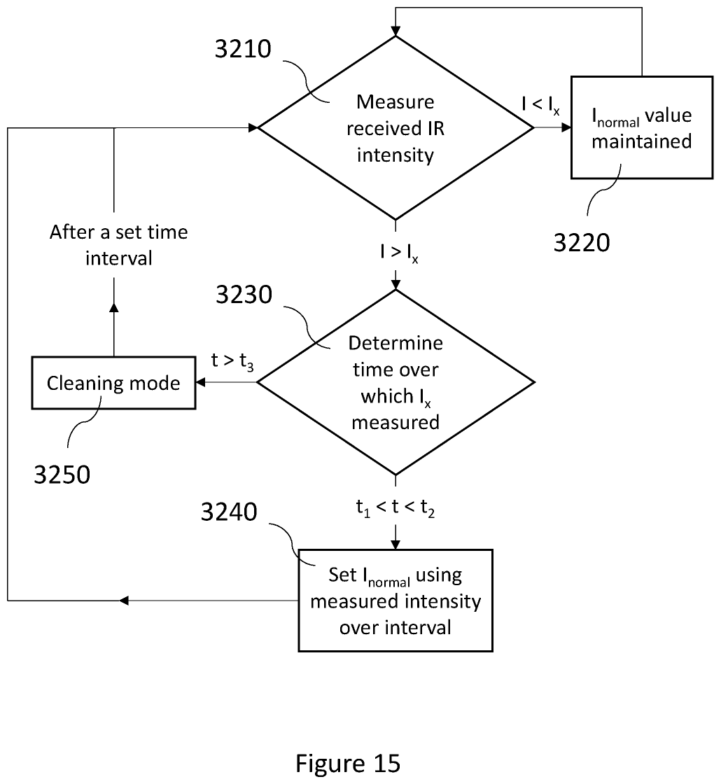

FIG. 15 illustrates an exemplary logic flow in which a value of Iₙₒᵣₘₐₗ (i.e., the activation intensity) is already defined. This may be followed when the system has already been ‘initialized’, for example as per the steps illustrated in FIGS. 13 and 14, or the system may be provided with pre-defined value of Iₙₒᵣₘₐₗ. The IR intensity is measured at step 3210, and if the value is above the threshold value, Iₓ, at step 3230 the system then determines the time interval over which the intensity value is above Iₓ. As described for the above embodiment, if the time interval is within a first range of t₁ to t₂, the system progresses to step 3240, in which the intensity value is measured over a time period and the normal value, Iₙₒᵣₘₐₗ, defined accordingly. If the intensity value is above Iₓ for a time interval greater than t₃, then the system instead enters the cleaning mode at step 3250. After either of these steps have been performed, the system moves back to step 3210, continuously measuring the IR intensity. If the intensity value is lower than the threshold value, Iₓ, then the value of Iₙₒᵣₘₐₗ is maintained. The value of Iₙₒᵣₘₐₗ may optionally be tweaked according to the continuous measurement of the reflectance of the air.

As described above, the ‘normal’ intensity value, Iₙₒᵣₘₐₗ, is defined as the detected intensity which indicates that the user's hand is raised into the activation position (which can also be referred to as the activation intensity). By setting the normal value, Iₙₒᵣₘₐₗ, within a small range, the system is less likely to be triggered to control the headlight settings by accidental movements. The processor is configured to trigger a change in the headlight or heater settings when the measured intensity value is equal to Iₙₒᵣₘₐₗ within a defined margin of error (i.e., indicating the user's hand is within a small distance of the activation position). The system may define a cycle of settings of the headlight, for example: off, low brightness, high brightness, off, and so on. Each time the measured intensity value is equal to the activation intensity, Iₙₒᵣₘₐₗ, the system is configured to cycle through the headlight settings. For example, the headlight is turned off, so the user moves their hand to the activation position to turn it on. It is initially turned on to the lowest brightness. The user then wants to increase the brightness, so moves their hand to the activation position once again, and the system cycles to high brightness. Later on, when the user wishes to turn the headlight off, they move their hand to the activation position once again, and the system moves to the next position in the settings cycle, which is the off state in the present example. In alternative examples, a different command may move the headlight to the off state, for example the user holding their hand to the activation position over a different time interval.

In a parallel manner, a user of the heating device can cycle through different set point temperatures. For example, the cycle of settings may comprise a combination of set point temperatures including any of: 35° C., 39° C., 45° C., 55° C., 60° C., and 68° C. The heater may start in an idle mode at room temperature and the user activates the system to scroll through the different settings in the same manner as is described above.

In some implementations of the invention, activation through the settings cycle may further be dependent on the time interval over which the user's hand is detected in the activation position. This can further aid in preventing accidental activation of changes to the settings. In various embodiments, a minimum time period for detection can be defined for the settings to change. For example, if the measured intensity is equal to Iₙₒᵣₘₐₗ for at least 2 seconds, the setting is moved to the next position in the cycle. In some implementations, a time range can be defined for the measurement of Iₙₒᵣₘₐₗ. For example, if the measured intensity is equal to Iₙₒᵣₘₐₗ for between 2 and 4 seconds, the setting is moved to the next position in the cycle. In some implementations, different time intervals can be defined for controlling different settings. For example, if the measured intensity is equal to Iₙₒᵣₘₐₗ for between 1 and 2 seconds, the headlight brightness or the heater temperature is moved to the next position in the cycle. However, turning the device on and off may be activated upon measurement of an intensity of Iₙₒᵣₘₐₗ for between 3 and 5 seconds.

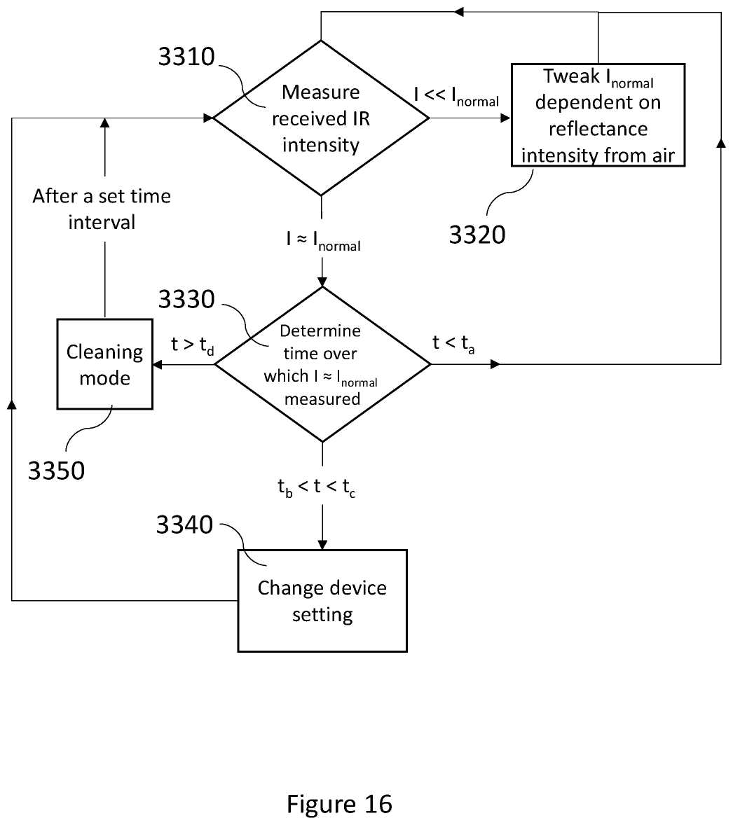

FIG. 16 illustrates an example logic flow for the activation of the changing the device settings depending on the length of time over which the measured intensity is equal to Iₙₒᵣₘₐₗ. At step 3310, the system measures the received IR intensity. If the measured intensity is approximately equal to Iₙₒᵣₘₐₗ, the system determines the time over which this occurs at step 3330. In this exemplary embodiment, if the time is less than a first value, tₐ, then the processor discounts the measurement and the system simply continues to perform measurements. If the time over which the measured intensity is approximately equal to Iₙₒᵣₘₐₗ is within a time range between t_{b} and t_{c}, the processor activates a change in the device setting (for example headlight settings or heating plate settings), cycling through the settings at step 3340. If the time is greater than a further defined time, t_{d}, then the system enters the cleaning mode at 3350. Once either of these actions have been performed, the system continues to perform proximity sensing, returning to step 3310. In some embodiments, tₐ equals to and/or t_{c} and equals t_{d}. In an exemplary embodiment, tₐ and t_{b} is equal to 2 seconds, t_{c} is equal to 4 seconds and t_{d} is equal to 6 seconds.

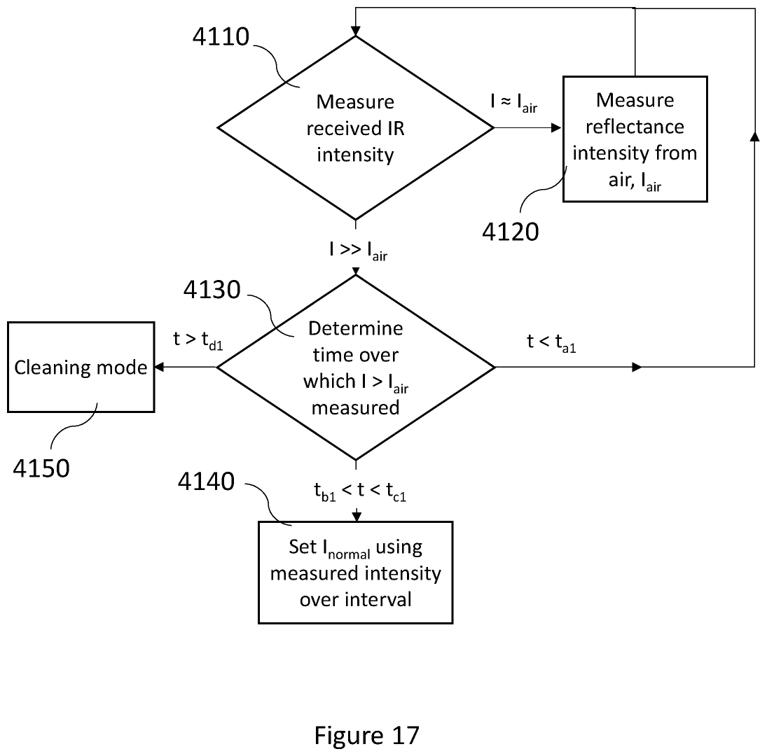

FIG. 17 illustrates the initialization steps of an alternative embodiment of the invention, in which the user is not required to touch the sensor (or bring their hand in very close proximity of the sensor) in order to start the calibration process. At step 4110, the system measures the reflected IR intensity. If the measured value is approximately equal to the value to be expected as a result of the reflectance of air, this is determined to be a measurement of the reflectance of air. At step 4120, the measured intensity is used to tweak the range of intensity values considered to be indicative of reflectance from air and indicative of reflectance from an object. If the intensity is significantly higher than the reflectance to be expected from air (i.e., the sensor detects the proximity of an object within its range), the system moves to step 4130, determining the time over which the increase in intensity is detected. If the time is less than a first value, tₐ₁, then the reading is discarded, and the system returns to sensing the IR intensity at step 4110. If the time interval is between t_{b1} and t_{c1}, at step 4140 the intensity measured over this time interval is used to determine Iₙₒᵣₘₐₗ, the intensity indicating that the user's hand is in the activation position. If the time interval is greater than a further defined time period, t_{d1}, the system enters the cleaning mode.

In some embodiments, the time intervals tₐ₁, t_{b1}, t_{c1} and t_{d1} correspond to the time intervals tₐ, t_{b}, t_{c} and t_{d}, such that the initial calibration is performed in a manner corresponding to the headlight or heater settings activation process (whether for a headlight, heating device or otherwise), as illustrated in FIG. 16.

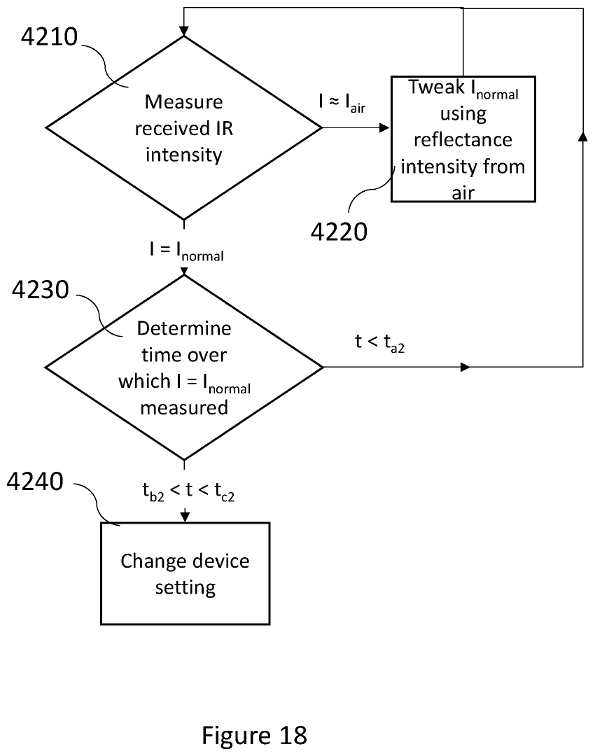

Alternatively, in some embodiments, the value of Iₙₒᵣₘₐₗ may be predefined by the system to correspond to a particular activation distance range. The associated process flow is shown in FIG. 18. The sensor measures the received IR intensity at step 4210. If the intensity value is determined to be within the range as defined for Iₙₒᵣₘₐₗ, the system moves to step 4230 in which it is determined the time interval over which Iₙₒᵣₘₐₗ is measured. If this time interval is less than a threshold value tₐ₁, then the system returns to step 4210. If the time interval is within a time range tₐ₂ to tₐ₂, then a setting of the device (for example brightness or setpoint temperature) is changed at step 4240. Additionally, if the reflected intensity it determined to be approximately Iₐᵢᵣ, then at step 4220, the measured intensity is used to tweak the range of intensity values considered to be indicative of reflectance from an object within the predetermined activation range. In some implementations, a further time interval may be defined for actuating the device to turn on and off in dependence on detecting Iₙₒᵣₘₐₗ over this further time interval.

The value of Iₙₒᵣₘₐₗ used in any of these processes may further be recalibrated in dependence on temperature measurements and/or settings, and or light level measurements.

### Exemplary Use of Headlight

In order to determine when a user is ‘activating’ the headlight, the sensor 1100, 2100 of the headlight arrangement 1000, 2000 will typically remain active. Thus, the sensor 1100, 2100 remains ‘on’ even when the headlight appears to be in the off state. This may therefore instead be referred to as an ‘idle’ state. The system may become fully turned off if the battery is detached from the headlight system, for example so as to charge it. In the particular case of the second exemplary embodiment of the illumination system 2000, in which the sensor 2100 is integral to the removable battery component, the battery may remain turned on for the duration of time it is connected to the headlight 2300. The processor can perform a check to determine whether the LED light is connected by performing a voltage measurement to determine the LED output. If there is no LED connected (or there is an error in the connection), the returned voltage should be equal to the output of the Power Supply Unit (PSU) or any converted (e.g. DC-DC Buck-Boost) In this instance, the battery enters a sleep mode. The processor can determine when the LED has been reattached when a voltage measurement within a threshold range is determined. For example, if the voltage is determined to be between 2.9 V to 3.2 V, it is determined that the LED is present. If the voltage is determined to be outside of these ranges, the system detects this an error and performs a system reset. (The processor itself consumes approximately 20-40 μA (typically dependant on battery voltage) while in “Sleep Mode/Idle Mode”. Once it ‘wakes up’ from the Sleep Mode/Idle Mode, it will consume approximately 20 mA for <200 ms to perform the LED Check.)

In normal use, when the sensor detects the proximity of the user's hand, an LED indicator light will typically be temporarily activated to show that the detection has taken place. This LED is typically a coloured LED, for example green. This activation by the ‘gesture’ causes the headlight to become turned on to a first setting. The cycle of brightness settings may have as the first setting the lowest illumination level, and then increase to higher illumination levels. Alternatively, the first setting may be the brightest setting and then the system cycles through decreasing levels of illumination in response to subsequent activations or ‘gestures’. Alternatively, the settings may be provided in any order. The user can repeat the gesture to cycle through the brightness settings until their desired brightness is reached. At each activation, the indicator light is temporarily illuminated or ‘flashes’. This headlight will remain at this brightness if no further ‘gestures’ are performed. Once the user has completed their task and wishes to turn the headlight off, they can perform further ‘gestures’ to cycle through the settings to reach the ‘off’ state. Alternatively, a different gesture may be used to turn the headlight off, such as holding a hand to the sensor for an increased duration. The headlight is switched to the off state, but the sensor remains actively sensing, as described above.

### Exemplary Use of Heater

When the heating device 5000 is in the idle state, the heating plate will not be actively heating and will be at ambient temperature. The sensor will nonetheless be active, so that when a user positions their hand above the sensor window 5120 for a sufficient time period, then the device will enter an active mode. This appears as the device being turned on, although the sensor remains active even in the idle or ‘turned off’ mode. The device being turned on is typically indicated by the illuminated ring 5130 becoming illuminated. It typically illuminated in different colours to indicate different temperatures. When the device is first turned on, it may be illuminated in the colour of the last setting prior to when the device was last turned off. Alternatively, it may be illuminated white, or may be illuminated in the colour of a pre-set ‘start-up’ setting.

In order to select a desired temperature, the user performs the ‘gesture’ by positioning their hand above the window 5120 of the sensor to cycle through the temperature setting options. The window 5120 may be comprised as, in, or in the vicinity of a ‘button’ or logo which can also be illuminated. As the user interacts with the window, the ‘button’ or logo may be illuminated to indicate to a user that they are interacting with the device. This illumination may typically be white. Each time a user ‘gestures’ by the window 5120, this may also trigger a temporary (for example, momentary) illumination or ‘flash’ of an LED in the window 5120 to indicate activation, as described for the illumination embodiment above (typically this is a green LED).

The temperature settings are typically arranged in ascending temperature order. They may, however, be provided in any order, for example by providing a most frequently used setting at the start of the cycle. As the user ‘gestures’ to cycle through the temperature settings, the illuminated ring 5130 changes colour. Each temperature setting is assigned one particular colour. Typical colours used may be red, green, blue, yellow, cyan and magenta, as can be created using an array of red, green and blue cathodes or separate LEDs. A user can select a particular temperature by simply performing no further ‘gestures’ above the window 5120 until the system has cycled to their desired temperature.

The LEDs of the illuminated ring 5130 can be illuminated in different patterns to indicate a setting or status of the device. These different patterns are achieved by illuminating the plurality of LEDs around the ring at different times and over different intervals. In this manner, different patterns and effects can be achieved. For example, while the user is cycling through the different temperature setting options, the illuminated ring 5130 may show a solid, uniform illumination. This can provide a clear indication to the user of the temperature setpoint they are choosing. The device will typically be provided with a key indicating which temperature each colour represents.

Once a temperature setpoint has been chosen, the processor of the heating device communicates to the heating elements to initiate heating of the heating plate 5200. There ensues a period of time in which the heating plate 5200 moves from its initial temperature (which may be ambient temperature, for example of between 20° C. and 25° C., or may be a previous temperature setpoint of the heating device) to the selected setpoint temperature. During this period of time, the illuminated ring 5130 displays a different illumination pattern to indicate that the heating plate 5200 is changing temperature. For example, LEDs may be illuminated over only a sector of the ring to indicate the progress of the heating. The angle of this sector can be increased to indicate the progression of the heating. The angle of the sector may preferably correspond to a fraction of a temperature range defined between a lower value and the setpoint. This may, for example, be between 10° C. and the setpoint temperature. If, for instance, the temperature of the heating plate 5200 is rising from an ambient temperature of 20° C. to a setpoint temperature of 39° C., the range is between 10° C. and 39° C. As such, when the heating plate is turned on and is at an ambient temperature of 20° C., then approximately one third of the illuminated ring 5130 is illuminated. Once the temperature of the heating plate 5200 reaches 39° C., the whole of the illuminated ring 5130 is illuminated. This can provide the user with an indication of the progression of the heating, and when the device is at the setpoint temperature.

Once the heating plate 5200 has reached the desired temperature, the illuminated ring 5130 may display a different effect again in order to indicate that the plate is at the correct temperature. This may simply be increased intensity of the solid colour, or may be a ‘breathing’ or pulsing effect. This can be achieved by ‘pulsing’ the illumination of the LEDs by cycling their intensity (for example, in a pattern of intensity values corresponding to a sine wave). The intensity variation is synchronized around the illuminated ring 5130. This creates a ‘breathing’ effect. Increased illumination intensity or a changing (or dynamic) illumination effect can be useful in reminding the user and anyone else present that the heating plate 5200 is currently hot, and as such provides a warning to be careful.

When a user changes between settings, the colour of the illuminated ring 5130 changes to the colour of the new setting. If the new setting is higher than the previous setting, the illuminated portion of the illuminated ring 5130 will reduce, corresponding to the position of the current temperature in the new temperature range. For example, if the setpoint temperature is changed from 39° C. to 45° C., the temperature range corresponding to the illumination of the ring changes from 10° C. to 39° C., to a range of 10° C. to 45° C. If the heating plate 5200 is at a temperature of 39° C., the illuminated ring 5130 will be fully illuminated before the setpoint temperature is changed. After the setpoint temperature is changed to 45° C., the temperature 39° C. is at approximately 83% along the new temperature range, and so approximately 83% of the illuminated ring 5130 will be illuminated.

In some implementations, as the illuminated fraction of the illuminated ring 5130 changes as the setpoint temperature is changed, the illumination is animated such that is appears to create a ‘bounce’ effect. This can be achieved by illuminating a changing fraction of the ring near the calculated fraction. By way of example, these offsets may be −10%, +7%, −4%, +2%, settle. For example, if the heating plate starts at a first setpoint temperature of 39° C., and then the user changes the setpoint temperature to 45° C., the illuminated percentage of the illuminated ring 5130 moves from 100% to 73%, then to 90%, then to 79%, then to 85%, then finally settles on 83%.

In alternative implementations, some or all of the animations may be omitted (or eliminated). For example, the illuminated ring 5130 may be illuminated in a solid colour, the colour depending on the current setpoint temperature.

The illuminated ring 5130 can, in the manner(s) described above, thus communicate information to the user. The colour can indicate the current setpoint temperature, and the illumination pattern can indicate the status of the heater 5000, in particular the heating plate 5200. This can eliminate the need for a user display, which can be difficult to disinfect and/or become faulty (often as result of regular use and cleaning).

### Alternatives and Modifications

Various other modifications will be apparent to those skilled in the art. It will be understood that the present invention has been described above purely by way of example, and modifications of detail can be made within the scope of the invention. Each feature disclosed in the description, and (where appropriate) the claims and drawings may be provided independently or in any appropriate combination.

The skilled person will appreciate that the loupes system may be tailored to different clinical or non-clinical environments while still implementing the inventive concepts. For example, the headlight could be provided on a monocular loupe such as a jeweller's loupe, which may be positioned on a user's face using a different arrangement.

The components may be provided in different combinations and relative positions. For example, the headlight can be provided at a different location of the glasses of the loupe arrangement. Similarly, the sensor can be provided at different locations on the loupe arrangement, and/or may face in a different direction. More than one sensor may be provided, and the different sensors may relate to different control commands. For example, one sensor may be used for powering the device on and off, and another for adjusting the brightness.

The skilled person will appreciate that the heating device may be provided as having a different shape and/or configuration. The heater has been described as configured to receive attachments, but it may alternatively be implemented as an integrated system comprising a heating head for the processing of relevant materials.

It should be understood that different set point temperatures of a heating device may be defined. These may be predefined, or, in some implementations, a user may be able to define their own set point temperatures.

The heating device may further comprise a logo, which becomes illuminated correspondingly with the illuminated ring. The illuminated logo may remain uniformly illuminated, thereby providing an indication of the current setpoint temperature even if the ring is displaying a dynamic effect or pattern. Alternatively, the illuminated logo may display a pattern or effect corresponding to or complementing the pattern of the illuminated ring. This may comprise a ‘pulsing’ or ‘breathing’ pattern of varying intensity.

Alternative lighting effects may be implemented in an illuminated component of any shape to convey the information as described and/or further information. The illumination effects may be dynamic or static, or a combination of the two. The illumination effects may be applied to the whole of the ring simultaneously or may vary or travel around the ring or alternative shape.

In different implementations of the invention, a different type of sensor may be used. Any sensor which can detect a gesture can be used. For example, an acoustic sensor or a visible light sensor could also be used to detect a user placing their hand near the sensor. Additionally, sensors using a different wavelength radiation can be used.

Different steps within the sensing method may be implemented in any combination. For example, any embodiment may further comprise updating Iₙₒᵣₘₐₗ as a result of changes in the reflectance value of air. Any embodiment may be implemented with or without a cleaning mode, or other similar power off mode. The skilled person will understand that different time intervals can be chosen, and that the relative lengths of the time intervals can be different to those described above.

The parameters defined in the description are exemplary only, and a skilled person will readily understand that different implementations of the invention may advantageously have different time intervals, intensity thresholds, sensor ranges (including angle of detection cone) etc.

Although described in terms of implementation in headlight systems and heating device systems, a skilled person will appreciate that the devices and processes described above can also be implanted in further devices and apparatus. Preferably, these are dental and/or medical devices and apparatus, but may also be, for example, culinary or cooking devices or apparatus. The inventions can be implemented in any electrical components, especially where it may be advantageous to discourage users touching a surface or device.

Those skilled in the art will understand that the processes described above can be implemented by hardware or by a programmable computer device that executes instructions stored in a memory to perform the methods described above. The invention therefore also extends to a computer implemented instructions product (signal or tangible medium) comprising computer implementable instructions which, when run on a programmable computer device, cause the programmable computer device to perform the methods described above.

Reference numerals appearing in the claims are by way of illustration only and shall have no limiting effect on the scope of the claims.

Further aspects of the invention are provided by way of the following clauses:

1. A device for eyewear, comprising a headlight, a sensor, and a processor.

2. A device for eyewear, the device comprising a headlight, and a battery and/or a sensor positioned atop the headlight.

3. A device comprising a battery configured to be affixable to eyewear, preferably wherein the battery is rechargeable.

4. A device comprising a sensor configured to be affixable to eyewear.

5. The device of any preceding clause, wherein the battery and/or sensor is reversibly connectable.

6. The device of clause 5, wherein the battery and/or sensor is reversibly connectable via a magnetic connection.

7. The device of any preceding clause, wherein the headlight and/or battery and/or sensor is configured to be positioned on a nose bridge of the eyewear.

8. The device of any preceding clause, comprising a processor, preferably wherein the processor is configured to be connected with the headlight and/or battery and/or sensor.

9. The device of clause 8, wherein the processor is configured to control settings of the headlight in dependence on an output of the sensor.

10. The device of clause 9, wherein the processor is configured to control on and off settings.

11. The device of clause 9 or 10, wherein the processor is configured to control brightness settings.

13. The device of any of clauses 1, 2 and 4 to 11, wherein the sensor is configured to continue sensing in a default mode.

14. The device of any of clauses 9 to 13, wherein the processor is configured to be adaptable to act in dependence on differing sensor conditions.

15. The device of clause 14, wherein the processor is configured to perform calibration.

16. The device of clause 15, wherein the calibration comprises recording a sensor condition.

17. The device of clause 15 or 16, wherein calibration is initiated upon detecting a sensor condition.

18. The device of any of clauses 14 to 17, wherein the processor is configured to adjust the sensor condition in dependence on detection of a baseline sensor condition.

19. The device of any of clauses 9 to 18, wherein the processor is configured to control settings in dependence on value of the sensor output.

20. The device of any of clauses 9 to 19, wherein the processor is configured to control settings in dependence on a duration of the sensor output.

21. The device of any of clauses 1, 2 and 4 to 20, wherein the sensor is a proximity sensor.

22. The device of clause 21, wherein the proximity sensor comprises an emitter configured to emit radiation and a detector configured to detect reflected radiation, and the processor is configured to determine proximity of an object in dependence on the intensity of the detected reflected radiation, preferably wherein the radiation is infrared radiation.

23. The device of clause 22, wherein the processor is configured to trigger a change in the settings upon detection of an activation intensity, preferably wherein the processor is configured to trigger a change in the settings of the headlight upon detection of an intensity within a range either side of the activation intensity.

24. The device of clause 23, wherein, upon measurement of the activation intensity, the processor is configured to move a step through a cycle of settings.

25. The device of clause 23 or 24, wherein the processor is configured to perform calibration to determine the activation intensity.

26. The device of clause 25, wherein the calibration comprises recording an intensity value and setting the activation intensity as the recorded intensity.

27. The device of clause 26, wherein the calibration is initiated upon detection of an intensity greater than a threshold value, preferably by detection of an intensity greater than a threshold value over a time interval within a predefined range.

28. The device of clause 27, wherein the threshold value is an intensity value greater than the intensity reflected from ambient conditions, preferably ambient conditions of air.

29. The device of clause 28 wherein the threshold value is between 60 to 100% of the emitted intensity, preferably between 70 to 98, more preferably between 80 and 95, even more preferably between 85 and 95%, and most preferably between 90 and 92%.

30. The device of any of clauses 23 to 29, wherein the processor is further configured to adjust the activation intensity in dependence on an intensity indicative of ambient conditions, preferably in dependence on an intensity indicative of reflectance of ambient air, and preferably continuously or at regular time intervals.

31. The device of any of clauses 23 to 30, wherein the processor is configured to power off the sensor and/or the headlight in dependence on detection of intensity above a threshold value over a particular interval, preferably wherein the processor is configured to turn the sensor and/or headlight back on again after a further time interval.

32. The device of any preceding clause, wherein the sensor comprises a window, wherein the window is semi-transparent.

33. The device of any of clauses 2, 3 and 5 to 32, wherein the battery is within a housing having the approximate shape of a cube.

34. The device of any of clauses 2, 3 and 5 to 33, wherein the battery is configured to be positioned behind a head of a user.

35. The device of any of clauses 1, 2 and 4 to 34, wherein the sensor is configured to be affixable on an arm of the eyewear.

36. The device of any of any of clauses 1, 2 and 4 to 35, wherein the sensor is a visible light sensor, preferably wherein the device further comprises a further sensor, the further sensor preferably being an infrared sensor.

37. The device of clause 36, wherein a power state of the device is dependent on an output of the visible light sensor.

38. The device of any preceding clause, further comprising connector cables between the headlight and/or battery and/or sensor.

39. The device of clause 38, further comprising a strap configured to secure the device over the head of a user, wherein strap comprises the connecting cables.

40. The device of any preceding clause, wherein the device is reversibly attachable to the eyewear.

41. The device of any preceding clause, configured for clinical use, preferably for use with loupes, most preferably for use with dental loupes.

42. An apparatus comprising the device of any of clauses 1 to 41, further comprising one or more of the following: a charger, one or more batteries, a strap, and eyewear; preferably wherein the charger is configured to charge the one or more batteries; and preferably wherein the eyewear comprises loupes.

43. A method of effecting an action in dependence upon detection of a sensor condition by a sensor.

44. The method of clause 43, comprising effecting an action in dependence on a sensor condition value and/or in dependence on the time interval over which the sensor condition is detected.

45. The method of clause 43 or 44, comprising the steps of:
Performing a calibrating step in dependence upon detecting a sensor condition above a threshold value, wherein the calibrating step comprises recording a sensor condition and defining a sensor condition value as an activation value; and
effecting an action in dependence on the sensor detecting the activation value.

46. The method of clause 45, further comprising effecting a different action in dependence on the time interval over which the activation value is detected.

47. The method of clause 45 or 46, wherein the calibrating step is performed in dependence upon detecting a sensor condition above a threshold value over a predetermined time interval.

48. A computer program product comprising computer implementable instructions for causing a programmable computer device to carry out the method of any of clauses 43 to 47.

1. A device comprising a processor, wherein the processor is configured to be connected with an electrical component and a proximity sensor, and wherein the processor is configured to control a setting of the electrical component in dependence on a sensor output corresponding to an activation intensity within an activation intensity range.

2. A device according to claim 1, wherein said activation intensity range is a range either side of the activation intensity.

3. A device according to claim 2, wherein said activation intensity range corresponds to an object being within a distance range of a particular activation position, preferably within ±1 cm of said particular activation position, more preferably within ±0.5 cm of said particular activation position.

4. A device according to claim 1, wherein the processor is configured to control a setting of the electrical component in dependence on a duration of the sensor output.

5. A device comprising a processor, wherein the processor is configured to be connected with an electrical component and a sensor, and wherein the processor is configured to control a setting of the electrical component in dependence on a duration of a sensor output.

6. A device according to claim 4, wherein the processor is configured to control settings in dependence on a minimum time interval over which the sensor output is detected.

7. A device according to claim 4, wherein the processor is configured to effect different actions in dependence on the duration over which the sensor output is detected.

8. A device according to claim 1, wherein the processor is configured to cycle a step through a cycle of settings in dependence on the sensor output, preferably wherein, upon measurement of the activation intensity, the processor is configured to cycle a step through the cycle of settings.

9. (canceled)

10. A device according to claim 1, wherein the setting or settings comprise; on and off.

11. A device according to claim 1, wherein the setting or settings comprise brightness levels and/or colours of at least one light source.

12. A device according to claim 1, wherein the settings comprise temperature settings of a heating device, preferably setpoint temperatures of a heating device.

13. A device according to claim 1, wherein the processor is configured to act in dependence on differing sensor conditions.

14. A device according to claim 13, wherein the processor is configured to adjust the sensor condition in dependence on detection of a baseline sensor condition, preferably in dependence on ambient conditions, more preferably in dependence on ambient air conditions, and/or preferably wherein the ambient conditions comprise visible light levels and/or temperature.

15. A device according to claim 1, wherein the sensor is a proximity sensor and further comprising the proximity sensor, preferably wherein the proximity sensor comprises a window, preferably wherein the window is semi-transparent.

16. A device according to claim 15, wherein the proximity sensor comprises an iris configured to attenuate radiation.

17. A device according to claim 1, further comprising a light source, preferably associated with the electrical component, configured to convey information, preferably wherein the electrical component is a heating device and the light source is configured to be illuminated in a portion indicating a relationship between a current temperature and a target temperature of the heating device.

18. (canceled)

19. (canceled)

20. A device according to claim 1, wherein the device is configured for clinical use and/or is formed of wipe-clean materials.

21. A device according to claim 1, further comprising the electrical component, preferably wherein the electrical component is a lighting component, a heating component, a dental tool component, an audio component, a camera component, a display component, a cooling component, a cleaning component and/or a curing tool component.

22. (canceled)

23. A method of controlling a setting of an electrical component in dependence on a sensor output corresponding to an activation intensity within an activation intensity range.

24. (canceled)

25. (canceled)

26. A non-transitory computer program product comprising computer implementable instructions for causing a programmable computer device to carry out the method of claim 23.
